(19) United States
(12) Patent Application Publication
(10) Pub. No.: US 2026/0134592 A1
(43) Pub. Date: May 14, 2026

(54) 3D VISUALIZATION OF DATACENTER ENTITIES, CONNECTIONS, AND METRICS

(71) Applicant: NVIDIA Corporation, Santa Clara, CA (US)

(72) Inventor: Elad Alon, Bellevue, WA (US)

(21) Appl. No.: 18/944,928

(22) Filed: Nov. 12, 2024

(51) Int. Cl. G06T 11/20; G06T 19/00

(52) U.S. Cl. CPC G06T 11/26; G06T 19/00

(57) ABSTRACT

Disclosed are systems and techniques for three-dimensional (3D) visualization of datacenter entities, connections, and metrics. The techniques include receiving datacenter state information representing a plurality of entities, one or more connections between the plurality of entities, and one or more entity properties for at least a first entity of the plurality of entities. The techniques further include generating a first view of a three-dimensional (3D) visualization of the datacenter state information. The 3D visualization of the datacenter includes at least first visual elements representing a first subset of the plurality of entities, second visual elements representing a second subset of the plurality of entities, and a third visual element representing a first connection of the one or more connections. A spatial position of at least a first visual element of the first visual elements is determined based on the one or more entity properties.

### TECHNICAL FIELD

At least one embodiment pertains to three-dimensional (3D) visualization of datacenter entities, connections, and metrics.

### BACKGROUND

Datacenters can host many (e.g., thousands of) graphics processing units (GPUs) and/or other processing units. The processing units can be contained within one or more hosts. The hosts can be connected to one or more other hosts via one or more switches. In some cases, switches can be connected to one or more other switches. In some cases, via the host and/or switch connections, each processing unit can access every other processing unit in the datacenter.

### BRIEF DESCRIPTION OF THE DRAWINGS

FIG. 1 is a block diagram of an example system for three-dimensional (3D) visualization of datacenter entities, connections, and metrics, according to at least one embodiment.

FIG. 2 is a block diagram of an example 3D datacenter visualization, according to at least one embodiment.

FIG. 3A is a diagram of part of a 3D datacenter visualization depicting visual elements representing datacenter entities positioned based on one or more entity properties, according to at least one embodiment.

FIG. 3B is a diagram of part of a 3D datacenter visualization depicting visual elements representing datacenter entities positioned based on one or more entity properties, according to at least one embodiment.

FIG. 3C is a diagram of part of a 3D datacenter visualization depicting visual elements representing datacenter entities positioned based on one or more entity properties, according to at least one embodiment.

FIG. 3D is a diagram of part of a 3D datacenter visualization depicting visual elements representing datacenter entities positioned based on one or more entity properties, according to at least one embodiment.

FIG. 3E is a diagram of part of a 3D datacenter visualization depicting visual elements representing datacenter entities positioned based on one or more entity properties, according to at least one embodiment.

FIG. 3F is a diagram of part of a 3D datacenter visualization depicting visual elements representing datacenter entities positioned based on one or more entity properties, according to at least one embodiment.

FIG. 4 is a flow diagram of an example method for three-dimensional (3D) visualization of datacenter entities, connections, and metrics, according to at least one embodiment.

FIG. 5A illustrates inference and/or training logic, according to at least one embodiment.

FIG. 5B illustrates inference and/or training logic, according to at least one embodiment.

FIG. 6 illustrates training and deployment of a neural network, according to at least one embodiment.

FIG. 7 is an example data flow diagram for an advanced computing pipeline, according to at least one embodiment.

FIG. 8 is a system diagram for an example system for training, adapting, instantiating and deploying machine learning models in an advanced computing pipeline, according to at least one embodiment.

FIG. 9 illustrates a computer system, according to at least one embodiment.

FIG. 10 illustrates a computer system, according to at least one embodiment.

FIG. 11 illustrates an exemplary data center, according to at least one embodiment.

### DETAILED DESCRIPTION

Due to the vast number of connections between entities (e.g., GPUs, central processing units (CPUs), data processing units (DPUs), servers, hosts, switches, etc.) within a datacenter, it can be difficult to visualize the connections between the entities. Aspects of the present disclosure provide for systems and techniques that allow for visualizing the connections between entities of a datacenter. More specifically, the present disclosure provides for systems and techniques for creating a three-dimensional (3D) digital representation (e.g., 3D visualization) of the entities within a datacenter and the connections between the entities. The 3D visualization can include a visual element for each entity of the datacenter and a visual element for each connection between two entities. The 3D visualization can depict a visual representation of the datacenter at a specific timestamp. In some embodiments, the visual representation can depict one or more metrics of the datacenter, the datacenter entities, and/or the datacenter connections.

In some embodiments, different entities and/or entity types (e.g., GPUs, CPUs, DPUs, servers, hosts, switches, etc.) are represented with a different visual element. The visual elements may differ in color, shape, size, and/or the like. For example, processors such as GPUs may be depicted as green cubes, hosts may be depicted as purple spheres, switches may be depicted as orange triangular prisms, and connections may be depicted as gray lines.

In some embodiments, the visual element used to represent an entity and/or connection of the datacenter can be determined based on one or more characteristics of the entity and/or connection. For example, a first level switch (e.g., a switch connected to hosts and other switches) may be depicted as an orange square, while a second level switch (e.g., a switch connected only to other switches) may be depicted as a red square.

In some embodiments, entities can be grouped in the 3D visualization to differentiate entity types. For example, GPUs and/or other processors can be shown on a first layer of the 3D visualization, first level switches can be shown on a second layer of the 3D visualization, and second level switches can be shown on a third layer of the 3D visualization.

In some embodiments, entities can be grouped in the 3D visualization based on one or more properties of the entity. For example, GPUs can have associated properties that include the GPU's host, the rack and/or aisle where the GPU is physically located in the datacenter, the device height in the rack, the rail (e.g., high speed communication group) the GPU is in, and/or the like. The entities can be positioned based on one or more properties, such that, for example, GPUs of the same host are located near one another in the 3D visualization. In another case, the GPUs of the same host can be located in the same position of another grouping, for example, a grouping by rail or rack. The order in which the properties of the GPUs are grouped can generate unique 3D visualizations.

In some embodiments, the 3D visualization can be configured to display a particular metric associated with the datacenter, the datacenter entities, and/or the datacenter connections. For example, the 3D visualization can be configured to display congestion of the connections of the datacenter. In some embodiments, a threshold can be set such that connections with congestion under the threshold are hidden while connections with congestion above the threshold are visible. In some embodiments, the congestion of each connection can be represented by the diameter of the line used to depict the connection. For example, a connection with high congestion can be depicted as a thick line, while a connection with minimal congestion can be depicted as a thin line.

As another example, the 3D visualization can be configured to display thermal metrics (e.g., device temperatures) of the entities of the datacenter. For example, the entities of the datacenter may be depicted as visual elements with different shapes to represent their entity type (e.g., cubes for GPUs, spheres for hosts, triangular prisms for switches, etc.). The color of each visual element may be used to depict the temperature of the entity, with cooler entities depicted with a blue color and warmer entities depicted with a red color, for example.

As the timestamp of the 3D visualization is changed, the visual elements of the 3D visualization can be changed to appropriately depict the state of the datacenter (e.g., which entities are present, the metrics at that timestamp, etc.) at that time. For example, at a first timestamp, the majority of the visual elements of the 3D visualization may be a blue color, representing having a cooler temperature (e.g., a temperature within an appropriate operating range). At a second timestamp, one or more of the visual elements of the 3D visualization may be a red color, representing having a warmer temperature (e.g., a temperature near the upper limit of the operating range). The warmer temperature at the second timestamp may be caused by faulty cooling systems, a window left open in a particular section of a datacenter, and/or the like.

A human operator can, based on the 3D visualization, take one or more corrective actions with regard to the datacenter. For example, in some cases, the human operator can redirect traffic that is causing congestion on one or more of the connections, GPUs, CPUs, DPUs, servers, switches, etc. In some cases, the human operator can remedy datacenter cooling issues depicted by the 3D visualization.

The advantages of the disclosed techniques include but are not limited to improved visualization of datacenter configurations and metrics, resulting in better resource utilization.

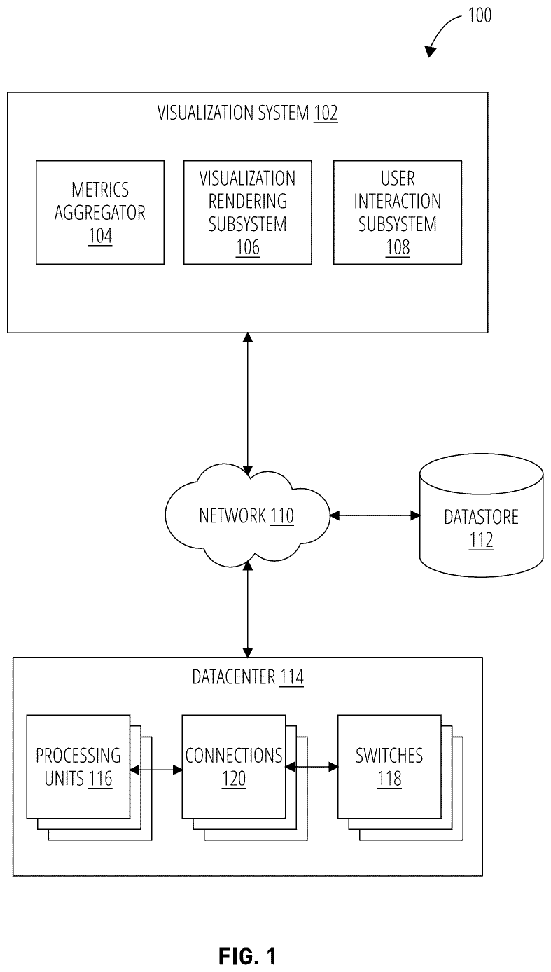

FIG. 1 is a block diagram of an example system 100 for three-dimensional (3D) visualization of datacenter entities, connections, and metrics, according to at least one embodiment. System 100 can include visualization system 102, datastore 112, and datacenter 114 connected via network 110. Network 110 can be a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

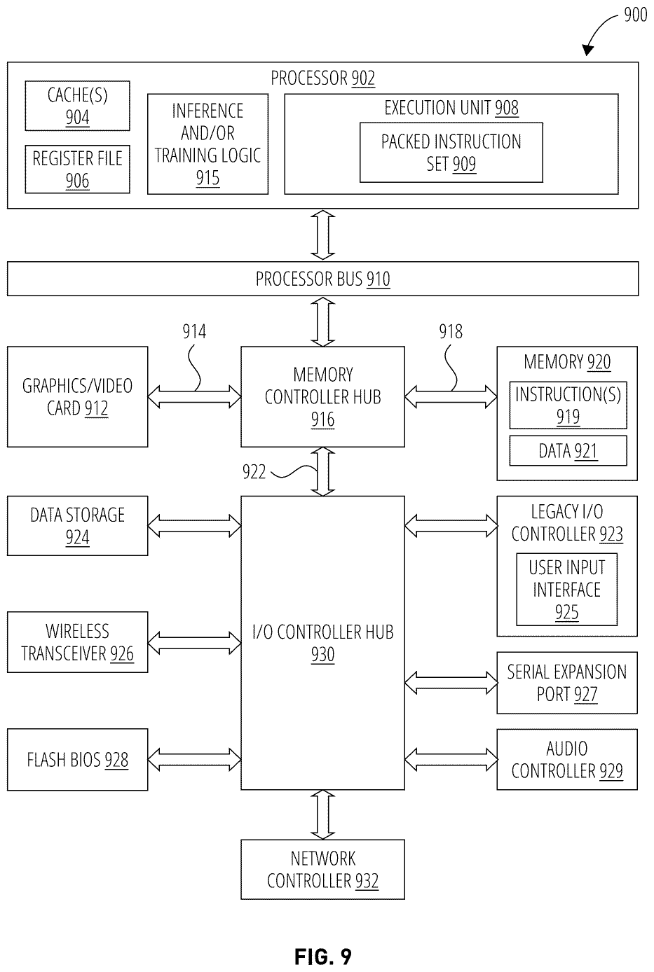

In some embodiments, visualization system 102 can be included within another system (e.g., computer system 900 of FIG. 9). For example, visualization system 102 can be comprised within a desktop computer, a server, a laptop, a mobile device, and/or the like. In some embodiments, datacenter 114 can be used to perform machine learning and/or artificial intelligence (AI) tasks. For example, datacenter 114 can be used for training AI models, performing inferencing using trained AI models, and/or the like.

Visualization system 102 can display (e.g., render, present, etc.) one or more visualizations of a datacenter (e.g., datacenter 114), including entities of the datacenter (e.g., graphics processing units (GPUs), CPUs, DPUs, servers, switches, hosts, etc.), connections between entities, and/or metrics of the datacenter. In some embodiments, the visualization is a 3D visualization depicting different entities in different layers of the visualization. In some embodiments, visual elements are positioned spatially within the visualization based on one or more properties of datacenter entities corresponding to the visual elements.

Visualization system 102 can include metrics aggregator 104, visualization rendering subsystem 106, and user interaction subsystem 108. Metrics aggregator 104 can collect and/or prepare metrics to be displayed within the visualization of the datacenter. Metrics aggregator 104 can receive metrics from datastore 112 and/or datacenter 114. The metrics can include information related to entities of the datacenter (e.g., temperature of an entity, resource utilization of an entity, bandwidth of an entity, etc.) and/or related to connections between entities of the datacenter (e.g., bandwidth of the connection, congestion of the connection, etc.). In some embodiments, the metrics include a timestamp, and visualization system 102 can display visualizations representing each timestamp, allowing a user to see how the metrics of the datacenter change over time.

In some embodiments, each entity of the datacenter can monitor and reports its metrics. In some embodiments, the metrics are aggregated in datastore 112. In some embodiments, the metrics are aggregated by a metrics aggregation service (e.g., metrics aggregator 104 or another metrics aggregator). For example, a processing unit may monitor its own temperature and bandwidth and provide the metrics periodically (e.g., every second, every minute, every five minutes, etc.) to a metrics endpoint of a metrics aggregation service. As another example, a switch may monitor congestion and bandwidth of each port of the switch and may periodically (e.g., every second, every minute, every five minutes, etc.) provide the metrics to a metrics endpoint of a metrics aggregation service.

Visualization rendering subsystem 106 can render and cause to be displayed (e.g., presented to a user) the visualization (e.g., 3D visualization) of the datacenter. The visualization can include visual elements that represent entities and connections of the datacenter. In some embodiments, different entities and/or entity types (e.g., GPUs, CPUs, DPUs, servers, hosts, switches, etc.) are represented with a different visual element. The visual elements may differ in color, shape, size, and/or the like. For example, GPUs may be depicted as green cubes, hosts may be depicted as purple spheres, switches may be depicted as orange triangular prisms, and connections may be depicted as gray lines.

In some embodiments, the visual element used to represent an entity and/or connection of the datacenter can be determined based on one or more characteristics of the entity and/or connection. For example, a first level switch (e.g., a switch connected to hosts and other switches) may be depicted as an orange cube, while a second level switch (e.g., a switch connected only to other switches) may be depicted as a red cube.

In some embodiments, entities can be grouped in the 3D visualization to differentiate entity types. For example, processing units (e.g., GPUs, CPUs, etc.) can be shown on a first layer of the 3D visualization, first level switches can be shown on a second layer of the 3D visualization, and second level switches can be shown on a third layer of the 3D visualization, etc.

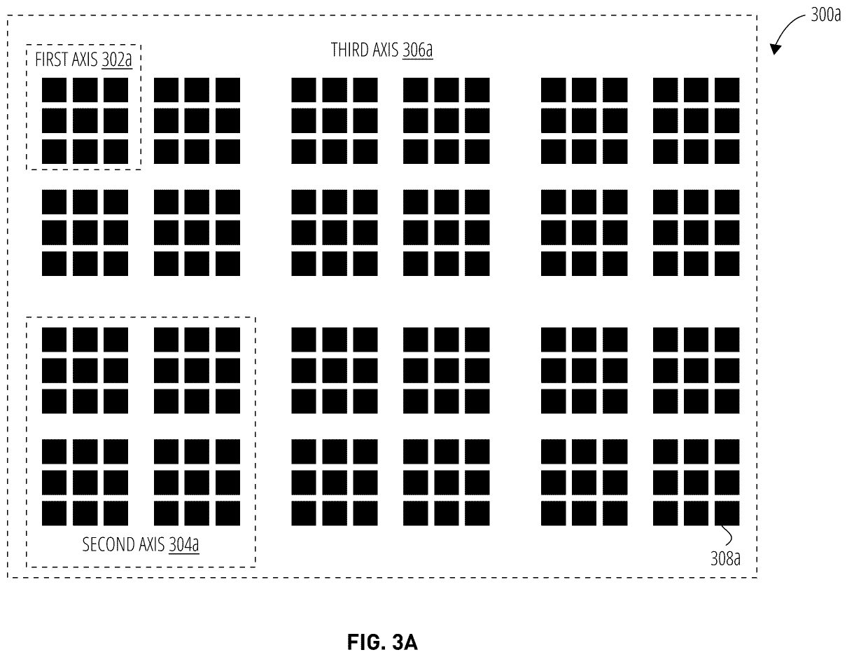

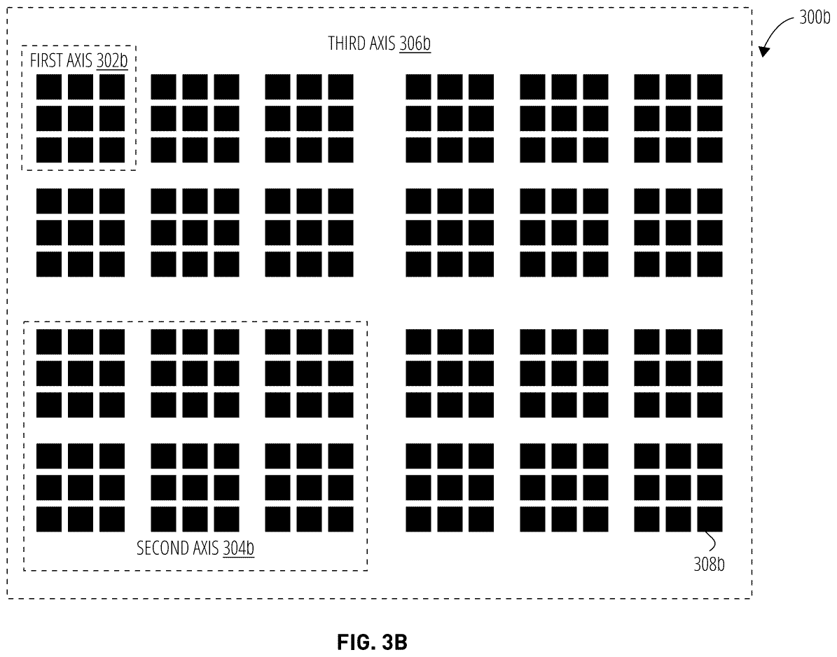

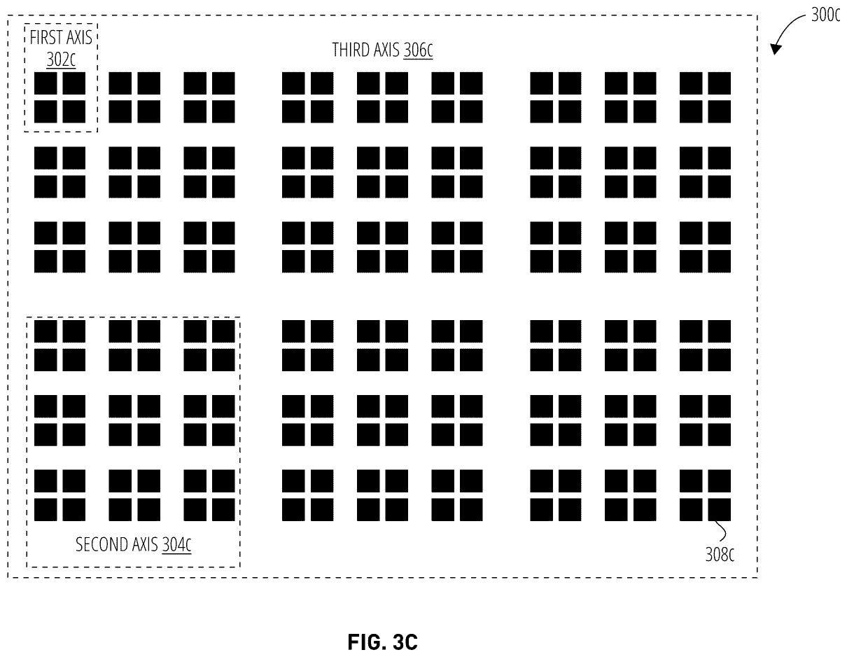

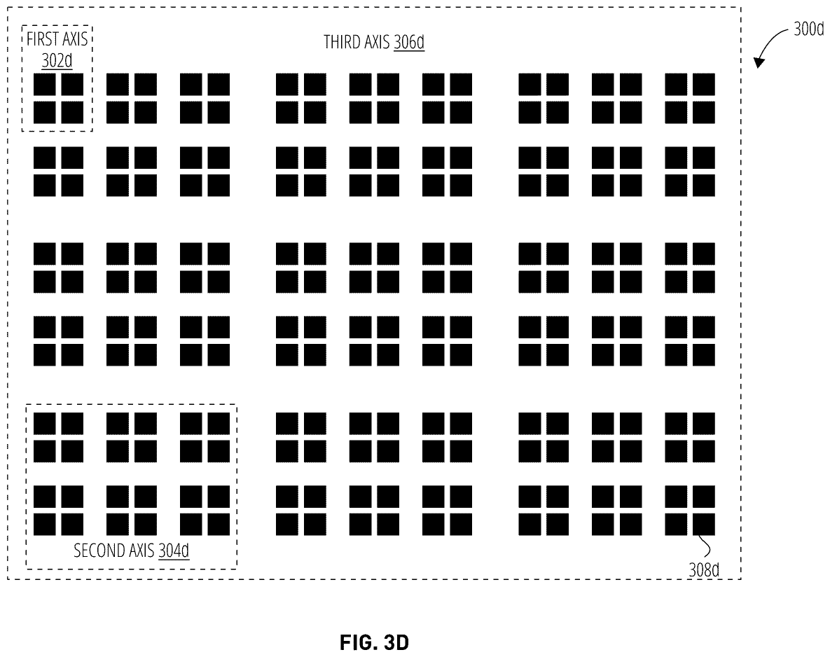

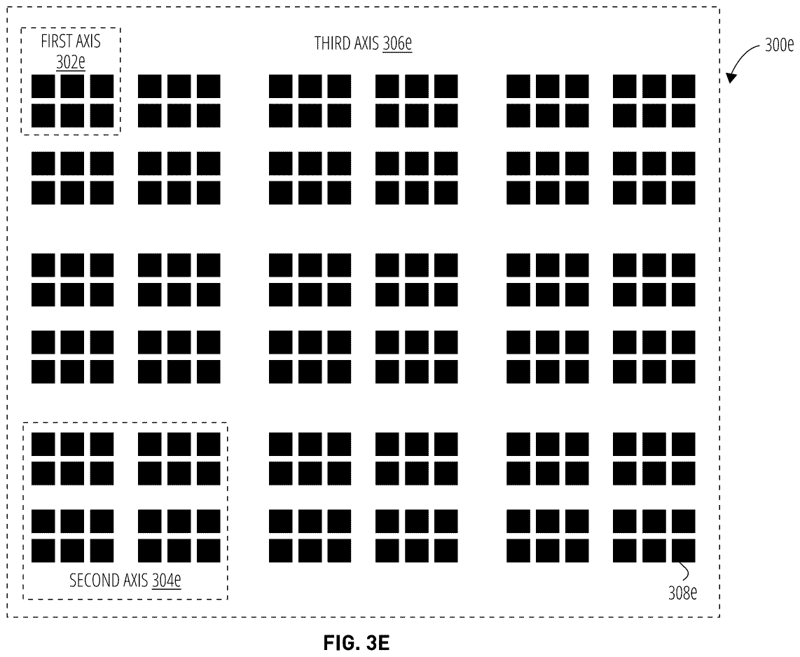

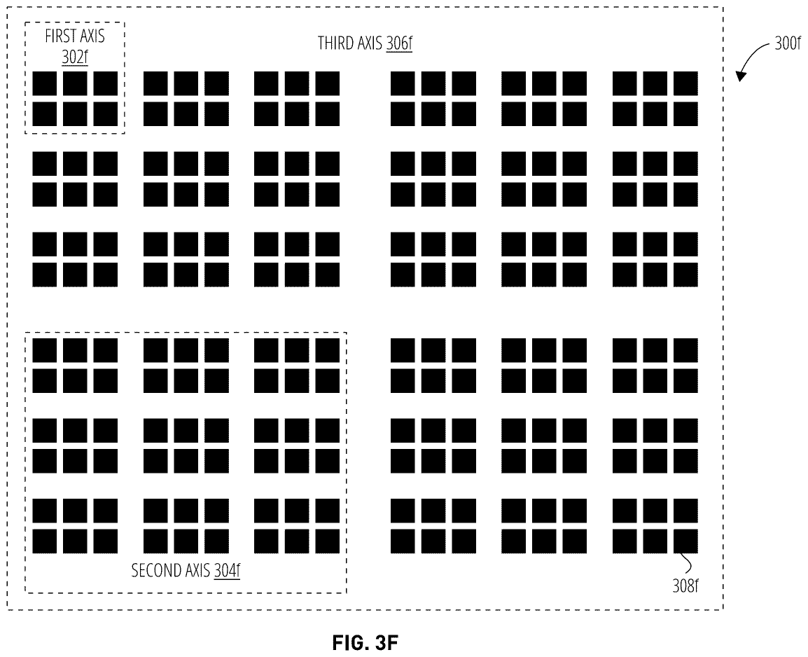

In some embodiments, entities can be grouped in the 3D visualization based on one or more properties of the entity. For example, GPUs can have associated properties that include the GPU's host, the rack and/or aisle where the GPU is physically located in the datacenter, the device height in the rack, the rail (e.g., high speed communication group) the GPU is in, and/or the like. The entities can be positioned based on one or more properties, such that, for example, GPUs of the same host are located near one another in the 3D visualization. In another case, the GPUs of the same host can be located in the same position of another grouping, for example, a grouping by rail or rack. The order in which the properties of the entities are grouped can generate unique 3D visualizations. See FIGS. 3A-3F for example entity groupings.

In some embodiments, the visualization can include a visual representation of multiple datacenters that operate as a single cluster. For example, the visualization may include a visual representation of a single cluster that includes a first datacenter in a first location (e.g., a first part of a building, a first building, a first city, etc.) and a second datacenter in a second location (e.g., a second part of a building, a second building, a second city, etc.). When a cluster includes entities in multiple datacenters, each entity may have one or more entity properties based on its host datacenter, such as a host datacenter identifier.

In some embodiments, the visualization can include visual representations of electrical connections within a datacenter. In some embodiments, the visualization can include visual representations of liquid cooling systems within a datacenter. In some embodiments, the visualization can show a change in topology of the datacenter over time (e.g., before and after a maintenance window where GPUs, CPUs, DPUs, servers, hosts, switches, etc. may have been added or removed). In some embodiments, the visualization can show how jobs are allocated (e.g., assigned to processing units for execution) throughout the datacenter.

In some embodiments, visualization rendering subsystem 106 can display a particular metric associated with the datacenter, the datacenter entities, and/or the datacenter connections. The metrics may come from datastore 112, metrics aggregator 104, or another metrics aggregation service. In some embodiments, a user can select one or more metrics from the metrics aggregation service to be displayed in the 3D visualization using an interactive visual element of the visualization. For example, a user may choose to visualize a congestion metric, and visualization rendering subsystem 106 can display congestion of the connections of the datacenter. In some embodiments, a threshold can be set (e.g., by a user interaction with an interactive visual element, automatically based on a preconfigured rule, etc.) such that connections with congestion under the threshold are hidden while connections with congestion above the threshold are visible. In some embodiments, a threshold can be set such that connections with congestion under the threshold are a first color (e.g., gray) while connections with congestion above the threshold are a second color (e.g., red). In some embodiments, the congestion of each connection can be represented by the diameter of the line used to depict the connection. For example, a connection with high congestion can be depicted as a thick line, while a connection with minimal congestion can be depicted as a thin line. In some embodiments, the congestion of a connection can be represented by additional visual elements appear alongside the connection, such as arrows, moving line segments, and/or the like.

As the timestamp of the 3D visualization is changed (e.g., via one or more user interactions handled by user interaction subsystem 108, via an animation feature of the 3D visualization that automatically changes the timestamp of the 3D visualization at a fixed interval, etc.), the visual elements of the 3D visualization can be changed to appropriately depict the state of the datacenter (e.g., which entities are present, the metrics at that timestamp, etc.) at that time. For example, at a first timestamp, the majority of the visual elements of the 3D visualization may be a blue color, representing having a cooler temperature (e.g., a temperature within an appropriate operating range). At a second timestamp, one or more of the visual elements of the 3D visualization may be a red color, representing having a warmer temperature (e.g., a temperature near the upper limit of the operating range). The warmer temperature at the second timestamp may be caused by faulty cooling systems, a window left open in a particular section of a datacenter, and/or the like.

A human operator can, based on the 3D visualization, take one or more corrective actions with regard to the datacenter. For example, in some cases, the human operator can redirect traffic that is causing congestion on one or more of the connections, processing units, switches, etc. In some cases, the human operator can remedy datacenter cooling issues depicted by the 3D visualization.

In some embodiments, the 3D visualization can be provided to an artificial intelligence (AI) model trained to interpret visual inputs. In some embodiments, the AI model may be trained to detect or predict congestion between entities of the datacenter. In some embodiments, the AI model may be able to provide suggestions to improve one or more metrics of the datacenter based on the 3D visualization. In some embodiments, an AI model may be able to parse datacenter state information instead of interpreting the visual representation of the datacenter state information.

User interaction subsystem 108 can receive and react to one or more user interactions with the visualization and can modify the visualization in response to the user interactions. For example, a user may click and drag a region of the 3D visualization. User interaction subsystem 108 can detect this interaction and cause visualization rendering subsystem 106 to render the 3D visualization at a new perspective, rotating the 3D visualization. In some embodiments, a user may interact with (e.g., click, select, change, etc.) visual elements of the 3D visualization. For example, a user may click on a visual element that represents a GPU in a datacenter. Upon clicking on the visual element, user interaction subsystem 108 can cause visualization rendering subsystem 106 to display a dialog or pop-up near (e.g., above, over, next to, under, etc.) the visual element. The dialog can include information about the datacenter entity corresponding to the visual element.

In some embodiments, a user can interact with the user interface to zoom in and out on the 3D visualization, pan the 3D visualization in one or more directions, rotate the 3D visualization about one or more axes, and so on. Additionally, a user can interact with the user interface to enable or disable visualizations of one or more layers of visual elements, of one or more types of connections, of connections failing to satisfy one or more criteria, of entities failing to satisfy one or more criteria, and so on.

In some embodiments, the 3D visualization includes a visualization control dialog. The visualization control dialog may allow a user to configure one or more properties of the visualization. For example, the visualization control dialog may include a slider element that allows a user to select a timestamp for the visualization. As the user changes the timestamp using the slider element, user interaction subsystem 108 can cause visualization rendering subsystem 106 to render a 3D visualization corresponding to the selected timestamp. In some embodiments, the visualization control dialog can allow a user to modify one or more metrics thresholds. For example, the visualization control dialog may include a metric(s) selector element, an upper threshold(s) selector element, and/or a lower threshold(s) selector element. As the selected metric(s), upper threshold(s), and/or lower threshold(s) are changed by a user, user interaction subsystem 108 can cause visualization rendering subsystem 106 to render a 3D visualization corresponding to the selected metric(s), upper threshold(s), and/or lower threshold(s).

For example, a user may select a “thermal” metric using the metric(s) selector element. Responsive to detecting the user interaction selecting the “thermal” metric, user interaction subsystem 108 can cause visualization rendering subsystem 106 to display a 3D visualization that depicts a thermal metric (e.g., device temperature) of each entity in the datacenter. For example, the color of each visual element may be used to depict the temperature of the entity, with cooler entities depicted with a blue color and warmer entities depicted with a red color. If the user selects an upper threshold for the thermal metric (e.g., using the upper threshold(s) selector element), user interaction subsystem 108 can cause visualization rendering subsystem 106 to display visual elements that represent entities with a device temperature below the upper threshold as a first color (e.g., gray) and to display visual elements that represent entities with a device temperature above the upper threshold as a second color (e.g., red). In some embodiments, a metric may have a single corresponding threshold (e.g., instead of an upper threshold and a lower threshold).

In some embodiments, the lower threshold and the upper threshold can form a range, and visual elements that represent entities with metrics within (or outside of) the range can be depicted or have one or more visual properties changed based on the value of the corresponding metric.

In some embodiments, a user can “collapse” a group of entities into a single visual element based on one or more entity properties. A user may be able to indicate (e.g., by interacting with one or more visual elements) that entities with the same entity property value (e.g., a common entity property value) should be collapsed into a single visual element. For example, if a rack has 24 entities and entities are collapsed based on their rack entity property, the entire rack of entities may be visually depicted as a single visual element (e.g., a particular visual element) instead of having 24 distinct visual elements.

In some embodiments, a user may be able to indicate that entities with the same entity property and a metric that satisfies a threshold criterion (e.g., an upper threshold, a lower threshold, etc.) should be collapsed into a single visual element. For example, a user may be able to indicate that entities with the same rack entity property that have a congestion metric lower than a particular threshold value should be depicted as a single visual element. This can “declutter” the 3D visualization by depicting congested entities as distinct visual elements and grouping one or more uncongested entities.

System 100 can include datastore 112, which can be a persistent storage that is capable of storing datacenter metrics, entity properties, connection properties, timestamp information, and/or the like. Datastore 112 may be hosted by one or more storage devices, such as main memory, magnetic or optical storage-based disks, tapes or hard drives, network attached storage (NAS), storage area network (SAN), and so forth. In some embodiments, datastore 112 may be a network-attached file server. In some embodiments, datastore 112 may be some other type of persistent storage such as an object-oriented database, a relational database, and so forth. In some embodiments, datastore 112 may be hosted on or may be a component of visualization system 102. In some embodiments, datastore 112 may be provided by a third-party service such as a cloud platform provider.

Datacenter 114 can be connected to datastore 112 and/or visualization system 102 via network 110. Datacenter 114 can include one or more entities, such as processing units 116 and switches 118, and one or more connections between the entities, such as connections 120. Processing units 116 can include one or more processors, including parallel processing devices. Switches 118 can include network switches connected to processing units 116 and/or connected to other switches (e.g., via connections 120).

Processing units 116 can have an associated host device (e.g., server, computer, etc.) and can have associated properties, such as a rack and/or aisle number where the processing unit is located in the datacenter, a height of the processing unit's host in the rack, a rail (e.g., high speed communication group) the processing unit is in, and/or the like. Visual elements corresponding to processing units 116 can have one or more visual properties based on the entity properties associated with processing units 116.

Switches 118 can have associated properties, such as a rack and/or aisle number where the switch is located in the datacenter, a switch level representing a layer in a hierarchy of switches (e.g., a first level switch may be connected to processing units, a second level switch may be connected to first level switches, a third level switch may be connected to second level switches, etc.), and/or the like. Each switch of switches 118 can include one or more ports for connections. For example, a switch may have 20 ports, which may allow the switch to be connected to 20 other devices (e.g., a combination of processing units and/or switches).

Connections 120 can include lines of communication between two entities of the datacenter. For example, some connections can be between a processing unit and a port of a switch. Some connections can be between a first switch and a second switch (e.g., from a first port of the first switch to a first port of a second switch). In some embodiments, one or more ports of a switch are optical receivers, and the corresponding connection is an optical connection. In some embodiments, connections 120 allow any processing unit of processing units 116 to communicate with any other processing unit of datacenter 114 (e.g., via one or more switches 118).

Datacenter 114 can provide datacenter state information to datastore 112 and/or visualization system 102. The datacenter state information can include and/or represent information related to each entity and/or connection of datacenter 114. In some embodiments, the datacenter state information includes and/or represents the properties of each entity and/or connection in datacenter 114. In some embodiments, the datacenter state information includes and/or represents metrics of the entities and/or connections of datacenter 114. For example, datacenter 114 may periodically (e.g., at a fixed interval, at random times, etc.) provide metrics of processing units 116 and each port of switches 118.

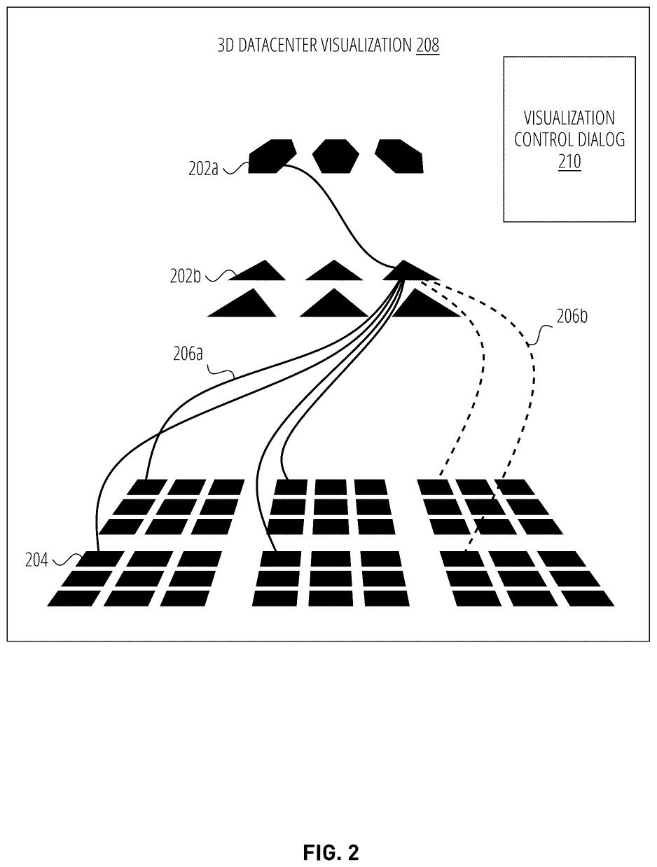

FIG. 2 is a block diagram of an example 3D datacenter visualization 208, according to at least one embodiment. 3D datacenter visualization 208 can include one or more layers of visual elements that represent entities of a datacenter (e.g., processing unit visual elements 204 on a first layer, switch visual elements 202b on a second layer, and switch visual elements 202a on a third layer) and visualization control dialog 210. Each layer of 3D datacenter visualization 208 can include visual elements that represent entities of a similar type. For example, switch visual elements 202a can include visual elements that represent level two switches (e.g., switches connected to level one switches (e.g., switch visual elements 202b)). Switch visual elements 202b can include visual elements that represent level one switches (e.g., switches connected to processing units (e.g., processing unit visual elements 204)).

In some embodiments, the visual elements of each layer of 3D datacenter visualization 208 have different visual properties, such as a size, a shape, a color, etc. For example, switch visual elements 202a can be depicted as hexagons (or hexagonal prisms), switch visual elements 202b can be depicted as triangles (or triangular prisms), and processing unit visual elements 204 can be depicted as squares (or rectangular prisms). In some embodiments, the visual elements of each layer can have the same shape and be depicted as different colors.

In some embodiments, 3D datacenter visualization 208 can include one or more connection visual elements 206a representing connections between entities of the datacenter. For example, one of switch visual elements 202a can be connected to one or more of switch visual elements 202b, which can, in turn, be connected to one or more of processing unit visual elements 204. In some embodiments, a visual property of a connection visual element can depict a metric of the corresponding connection. For example, connection visual elements 206b can be depicted with dashed lines to indicate a congestion metric that exceeds a congestion threshold. In some embodiments, the dashed lines can be moving up or down to indicate a direction of the congestion metric.

In some embodiments, 3D datacenter visualization 208 can be rendered (e.g., displayed) at a first timestamp with a first set of visual elements and metrics and at a second timestamp with a second set of visual elements and metrics. In some embodiments, 3D datacenter visualization 208 can be rendered (e.g., displayed) at more than one perspective. For example, a viewing angle of 3D datacenter visualization 208 can be changed to view the visual elements of 3D datacenter visualization 208 from a different perspective. By changing the viewing angle, 3D datacenter visualization 208 can be rotated, zoomed in/out, and/or the like.

In some embodiments, 3D datacenter visualization 208 can be modified based on visualization control dialog 210. Visualization control dialog 210 can include one or more elements to allow a user to modify 3D datacenter visualization 208. For example, visualization control dialog 210 can include an element (e.g., a slider element, an input field, etc.) to allow a user to select a timestamp to be displayed in 3D datacenter visualization 208. In some embodiments, visualization control dialog 210 can include one or more elements for selecting one or more metrics to be displayed in 3D datacenter visualization 208. In some embodiments, visualization control dialog 210 can include one or more elements for setting a threshold (e.g., an upper threshold, a lower threshold, a range, etc.) for one or more metrics.

After interacting with visualization control dialog 210, a new or otherwise updated 3D datacenter visualization 208 can be displayed corresponding to the options selected by the user. In some embodiments, visualization control dialog 210 can include one or more elements for changing a grouping of the visual elements of 3D datacenter visualization 208. In some embodiments, the datacenter visualization 208 can be overlaid on top of a digital twin of the datacenter, allowing for an interactive, real-time representation of key metrics and operations within the virtual model. This overlay provides enhanced insights by aligning data streams with the spatial and operational layout of the datacenter, enabling users to intuitively monitor, analyze, and respond to conditions as they unfold within the simulated environment. By integrating the visualization with the digital twin, users can make more informed decisions based on a holistic, visual representation of the datacenter's current state and projected scenarios.

FIG. 3A-FIG. 3F illustrate multiple different possible visualizations of a layer of a 3D datacenter visualization. Each of the multiple possible visualizations depict different groupings of entities at a shown layer. In some embodiments, a user may select, define, and/or change groupings of the entities, which may cause a user interface to provide different visualizations. For example, a user may define the groupings in a configuration file of the 3D visualization. In some embodiments, the 3D visualization may include one or more interactive visual elements to allow a user to modify the groupings of entities within the 3D visualization. For example, a user may be able to select one or more entity properties to be used for grouping entities of a particular layer of the 3D visualization. A user may also be able to select the order in which the entity properties are grouped, which can affect the layer's appearance, as shown in FIG. 3A-FIG. 3F. Each layer can be individually customized to display specific groupings of entities within that layer. These customized views can be shown independently for a single layer, allowing focused analysis of a particular network entity type, or displayed simultaneously with one or more other layers, each retaining its own unique grouping configuration. This flexibility enables users to view either isolated or combined layers, with each layer's customization intact, facilitating both detailed and integrated monitoring of network entities across the data center.

FIG. 3A is a diagram of part of a 3D datacenter visualization depicting visual elements representing datacenter entities positioned based on one or more entity properties, according to at least one embodiment. Visualization 300a can include visual elements (such as entity visual element 308a) that represent entities of a datacenter. In some embodiments, visualization 300a is of entities in a first or bottom layer of a datacenter (e.g., of processing units such as GPUs). For example, visualization 300a can include a plurality of black squares that each represent a processing unit in a datacenter. In some embodiments, visualization 300a can be included in a layer of a 3D visualization of a datacenter.

The visual elements of visualization 300a can be grouped based on one or more properties of the corresponding datacenter entities. In some embodiments, the visual elements can be grouped based on a combination of two properties, which can form a grouping axis. In some embodiments, a single property can form a grouping axis. The visual elements of visualization 300a can be grouped by multiple grouping axes, and the order of the grouping axes can determine how the final visualization will appear.

In some embodiments, the one or more grouping axes are depicted visually in the 3D visualization. For example, elements in a group may be surrounded by a visual element (e.g., a rectangle, a circle, a polygon, etc.). As another example, elements in a group may have a similar color or may be raised or lowered slightly as compared to elements of another group.

For example, in visualization 300a, the visual elements are grouped by first axis 302a which is a 3×3 axis. In some embodiments, first axis 302a is based on two properties of the entity represented by the visual elements (e.g., based on a processing unit's rack number and height within the rack). In some embodiments, first axis 302a is based on a single property of the entity (e.g., based on the number of the processing units within a particular host).

In some embodiments, axes that are based on a single property can be displayed in a square that is closest to the number of possible values of the single property. For example, a host of the datacenter may be able to host 8 GPUs. Therefore, entity property corresponding to the number of the GPU in the host can range from 1-8. The smallest square to represent 8 values is 3 squared (9). Thus, when visual elements are grouped based on the single property corresponding to the number of the GPU in the host, the visual elements can be arranged in a 3×3 square, and one slot of the square can be empty. If the single entity property had up to 12 possible values, the smallest square to represent those values could be 4 squared (16), and the visual elements could be arranged in a 4×4 square with 4 empty slots.

In some embodiments, axes that are based on a single entity property can be displayed as a rectangle that is closest to the number of possible values of the single property. For example, in some embodiments, the visual elements corresponding to each of 8 possible values can be arranged in a 2×4 or 4×2 rectangle, and the visual elements corresponding to each of 12 possible values can be arranged in a 3×4 or 4×3 rectangle.

In some embodiments, axes that are based on a combination of two entity properties can be displayed as a rectangle with the number of visual elements along the first edge of the rectangle corresponding to the possible values of the first entity property and the number of visual elements along the second edge of the rectangle corresponding to the possible values of the second entity property. For example, a set of entities may be grouped along an axis based on two entity properties: rack and height within the rack. If there are 4 racks and 8 levels (e.g., “heights”) within each rack, the visual elements representing the entities grouped along this axis may be displayed in a 4×8 rectangle or an 8×4 rectangle.

Visual elements in the same spot relative to a grouping can have the same entity property or properties. For example, visual elements in the top left corner of each grouping along first axis 302a can have the same entity property value corresponding to first axis 302a. As another example, all the visual elements in the top middle grouping along second axis 304a can have the same entity property value corresponding to second axis 304a.

After grouping the visual elements of visualization 300a based on first axis 302a, the groupings along first axis 302a can be grouped along second axis 304a, which is a 2×2 axis. In some embodiments, second axis 304a is based on two properties of the entity represented by the visual elements. In some embodiments, second axis 304a is based on a single property of the entity.

After grouping the visual elements of visualization 300a based on first axis 302a and second axis 304a, the groupings along second axis 304a can be grouped along third axis 306a, which is a 2×3 axis. In some embodiments, third axis 306a is based on two properties of the entity represented by the visual elements. In some embodiments, third axis 306a is based on a single property of the entity.

The resulting visualization 300a includes groups along first axis 302a (3×3 groups) arranged in groups along second axis 304a (2×2 groups) which are in turn arranged in groups along third axis 306a (2×3 groups).

FIG. 3B is a diagram of part of a 3D datacenter visualization depicting visual elements representing datacenter entities positioned based on one or more entity properties, according to at least one embodiment. Visualization 300b can include visual elements (such as entity visual element 308b) that represent entities of a datacenter. For example, visualization 300b can include a plurality of black squares that each represent a processing unit in a datacenter. In some embodiments, visualization 300b can be included in a layer of a 3D visualization of a datacenter.

Similar to the visual elements in FIG. 3A, the visual elements of visualization 300b can be grouped based on one or more properties of the corresponding datacenter entities. In some embodiments, the visual elements can be grouped based on a combination of two properties, which can form a grouping axis. In some embodiments, a single property can form a grouping axis. The visual elements of visualization 300b can be grouped by multiple grouping axes, and the order of the grouping axes can determine how the final visualization will appear.

For example, in visualization 300b, the visual elements are grouped by first axis 302b which is a 3×3 axis. After grouping the visual elements of visualization 300b based on first axis 302b, the groupings along first axis 302b can be grouped along second axis 304b, which is a 2×3 axis. After grouping the visual elements of visualization 300b based on first axis 302b and second axis 304b, the groupings along second axis 304b can be grouped along third axis 306b, which is a 2×2 axis. The resulting visualization 300b includes groups along first axis 302b (3×3 groups) arranged in groups along second axis 304b (2×3 groups) which are in turn arranged in groups along third axis 306b (2×2 groups).

FIG. 3C is a diagram of part of a 3D datacenter visualization depicting visual elements representing datacenter entities positioned based on one or more entity properties, according to at least one embodiment. Visualization 300c can include visual elements (such as entity visual element 308c) that represent entities of a datacenter. For example, visualization 300c can include a plurality of black squares that each represent a processing unit in a datacenter. In some embodiments, visualization 300c can be included in a layer of a 3D visualization of a datacenter.

Similar to the visual elements in FIG. 3B, the visual elements of visualization 300c can be grouped based on one or more properties of the corresponding datacenter entities. In some embodiments, the visual elements can be grouped based on a combination of two properties, which can form a grouping axis. In some embodiments, a single property can form a grouping axis. The visual elements of visualization 300c can be grouped by multiple grouping axes, and the order of the grouping axes can determine how the final visualization will appear.

For example, in visualization 300c, the visual elements are grouped by first axis 302c which is a 2×2 axis. After grouping the visual elements of visualization 300c based on first axis 302c, the groupings along first axis 302c can be grouped along second axis 304c, which is a 3×3 axis. After grouping the visual elements of visualization 300c based on first axis 302c and second axis 304c, the groupings along second axis 304c can be grouped along third axis 306c, which is a 2×3 axis. The resulting visualization 300c includes groups along first axis 302c (2×2 groups) arranged in groups along second axis 304c (3×3 groups) which are in turn arranged in groups along third axis 306c (2×3 groups).

FIG. 3D is a diagram of part of a 3D datacenter visualization depicting visual elements representing datacenter entities positioned based on one or more entity properties, according to at least one embodiment. Visualization 300d can include visual elements (such as entity visual element 308d) that represent entities of a datacenter. For example, visualization 300d can include a plurality of black squares that each represent a processing unit in a datacenter. In some embodiments, visualization 300d can be included in a layer of a 3D visualization of a datacenter.

Similar to the visual elements in FIG. 3C, the visual elements of visualization 300d can be grouped based on one or more properties of the corresponding datacenter entities. In some embodiments, the visual elements can be grouped based on a combination of two properties, which can form a grouping axis. In some embodiments, a single property can form a grouping axis. The visual elements of visualization 300d can be grouped by multiple grouping axes, and the order of the grouping axes can determine how the final visualization will appear.

For example, in visualization 300d, the visual elements are grouped by first axis 302d which is a 2×2 axis. After grouping the visual elements of visualization 300d based on first axis 302d, the groupings along first axis 302d can be grouped along second axis 304d, which is a 2×3 axis. After grouping the visual elements of visualization 300d based on first axis 302d and second axis 304d, the groupings along second axis 304d can be grouped along third axis 306d, which is a 3×3 axis. The resulting visualization 300d includes groups along first axis 302d (2×2 groups) arranged in groups along second axis 304d (2×3 groups) which are in turn arranged in groups along third axis 306d (3×3 groups).

FIG. 3E is a diagram of part of a 3D datacenter visualization depicting visual elements representing datacenter entities positioned based on one or more entity properties, according to at least one embodiment. Visualization 300e can include visual elements (such as entity visual element 308e) that represent entities of a datacenter. For example, visualization 300e can include a plurality of black squares that each represent a processing unit in a datacenter. In some embodiments, visualization 300e can be included in a layer of a 3D visualization of a datacenter.

Similar to the visual elements in FIG. 3D, the visual elements of visualization 300e can be grouped based on one or more properties of the corresponding datacenter entities. In some embodiments, the visual elements can be grouped based on a combination of two properties, which can form a grouping axis. In some embodiments, a single property can form a grouping axis. The visual elements of visualization 300e can be grouped by multiple grouping axes, and the order of the grouping axes can determine how the final visualization will appear.

For example, in visualization 300e, the visual elements are grouped by first axis 302e which is a 2×3 axis. After grouping the visual elements of visualization 300e based on first axis 302e, the groupings along first axis 302e can be grouped along second axis 304e, which is a 2×2 axis. After grouping the visual elements of visualization 300e based on first axis 302e and second axis 304e, the groupings along second axis 304e can be grouped along third axis 306e, which is a 3×3 axis. The resulting visualization 300e includes groups along first axis 302e (2×3 groups) arranged in groups along second axis 304e (2×2 groups) which are in turn arranged in groups along third axis 306e (3×3 groups).

FIG. 3F is a diagram of part of a 3D datacenter visualization depicting visual elements representing datacenter entities positioned based on one or more entity properties, according to at least one embodiment. Visualization 300f can include visual elements (such as entity visual element 308f) that represent entities of a datacenter. For example, visualization 300f can include a plurality of black squares that each represent a processing unit in a datacenter. In some embodiments, visualization 300f can be included in a layer of a 3D visualization of a datacenter.

Similar to the visual elements in FIG. 3E, the visual elements of visualization 300f can be grouped based on one or more properties of the corresponding datacenter entities. In some embodiments, the visual elements can be grouped based on a combination of two properties, which can form a grouping axis. In some embodiments, a single property can form a grouping axis. The visual elements of visualization 300f can be grouped by multiple grouping axes, and the order of the grouping axes can determine how the final visualization will appear.

For example, in visualization 300f, the visual elements are grouped by first axis 302f which is a 2×3 axis. After grouping the visual elements of visualization 300f based on first axis 302f, the groupings along first axis 302f can be grouped along second axis 304f, which is a 3×3 axis. After grouping the visual elements of visualization 300f based on first axis 302f and second axis 304f, the groupings along second axis 304f can be grouped along third axis 306f, which is a 2×2 axis. The resulting visualization 300f includes groups along first axis 302f (2×3 groups) arranged in groups along second axis 304f (3×3 groups) which are in turn arranged in groups along third axis 306f (2×2 groups).

Thus, each visualization 300a-f can depict the same 216 datacenter entities, each grouped in a different way based on the order of the grouping axes.

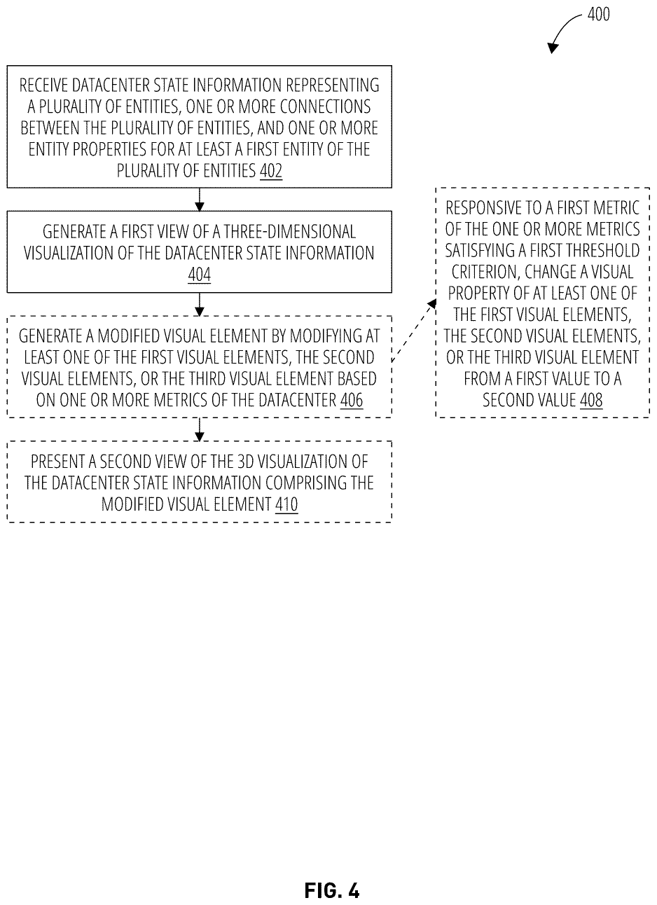

FIG. 4 is a flow diagram of an example method 400 for three-dimensional (3D) visualization of datacenter entities, connections, and metrics, according to at least one embodiment. Method 400 can be performed using one or more processing units (e.g., CPUs, GPUs, accelerators, physics processing units (PPUs), data processing units (DPUs), etc.), which may include (or communicate with) one or more memory devices. In at least one embodiment, method 400 can be performed using a processing device or processing devices. In at least one embodiment, method 400 can be performed using processing circuitry. In at least one embodiment, method 400 can be performed using processing units of visualization system 102 of FIG. 1. In at least one embodiment, processing units performing method 400 can be executing instructions stored on a non-transient computer readable storage media. In at least one embodiment, method 400 can be performed using multiple processing threads (e.g., CPU threads and/or GPU threads), individual threads executing one or more individual functions, routines, subroutines, or operations of the method. In at least one embodiment, processing threads implementing method 400 can be synchronized (e.g., using semaphores, critical sections, and/or other thread synchronization mechanisms). Alternatively, processing threads implementing method 400 can be executed asynchronously with respect to each other. Various operations of method 400 can be performed in a different order compared with the order shown in FIG. 4. Some operations of method 400 can be performed concurrently with other operations. In at least one embodiment, one or more operations shown in FIG. 4 may not always be performed.

At block 402, processing units executing method 400 can receive datacenter state information representing a plurality of entities, one or more connections between the plurality of entities, and one or more entity properties for at least a first entity of the plurality of entities. For example, the datacenter state information can include a description of each entity of the datacenter. Each description can include one or more properties of the entity. The datacenter state information can include data indicating which entities are connected by which connections. In some embodiments, the datacenter state information is provided by a datacenter and/or network management service, such as NVIDIA Unified Fabric Manager®. In some embodiments, the entities can include one or more of GPUs, CPUs, DPUs, servers, switches, hosts, racks (e.g., server racks), and/or the like.

At block 404, processing units can generate a first view of a three-dimensional (3D) visualization of the datacenter state information. The 3D visualization of the datacenter state information can include first visual elements representing a first subset of the plurality of entities (e.g., GPUs), second visual elements representing a second subset of the plurality of entities (e.g., switches), and a third visual element representing a first connection of the one or more connections (e.g., a connection between a first GPU and a first switch). In some embodiments, a spatial position of at least a first visual element of the first visual elements is determined based on the one or more entity properties.

For example, the first visual element may represent a GPU of the datacenter. It may be positioned spatially within the 3D visualization based on one or more of its entity properties, such as its host in the datacenter, the rack where the GPU is located, a height of the GPU within the rack, etc. For example, the first visual element may be positioned near (e.g., in a group of) visual elements representing other GPUs that are all in the same host.

The first visual elements can have a first visual property including at least one of a shape, a color, or a size. The second visual elements can have a second visual property including at least one of a shape, a color, or a size. In some embodiments, the first visual property is different than the second visual property. For example, the first visual elements may represent GPUs of the datacenter and may be depicted as green squares (or cubes or rectangular prisms) in the 3D visualization, while the second visual elements may represent first level switches of the datacenter and may be depicted as orange triangular prisms.

In some embodiments, a visual element representing a connection of the datacenter may have one or more visual properties that depict a direction associated with the connection. For example, a connection may be used for communications in one direction (e.g., from a switch to a GPU). The direction of communications may be depicted by arrows, moving line segments, a color, and/or the like. In some embodiments, a connection may be used for communications in both directions (e.g., from a switch to a GPU and from the GPU to the switch), but a metric of the connection (e.g., congestion) may have only one direction. In some embodiments, the direction of the metric of the connection can be depicted separately from the depiction of the connection. For example, the connection may be depicted as a gray line, but congestion of the connection may be depicted as red arrows that are moving in one direction along the gray line.

In some embodiments, processing units can, responsive to receiving a first user interaction, present a second view of the 3D visualization of the datacenter state information. The second view of the 3D visualization of the datacenter state information can have a different perspective than the first view of the 3D visualization of the datacenter state information. For example, a user may click and drag a region of the 3D visualization which can cause the 3D visualization to rotate, causing a new perspective of the 3D visualization to be displayed.

In some embodiments, the datacenter state information can represent one or more metrics of the datacenter. For example, the metrics can include information about the entities of the datacenter (e.g., utilization, temperature, bandwidth, etc.) and/or about the connections of the datacenter (e.g., bandwidth, congestion, etc.). At block 406, processing units can generate a modified visual element by modifying at least one of the first visual elements, the second visual elements, or the third visual element based on the one or more metrics of the datacenter.

In some embodiments, at block 408, responsive to a first metric of the one or more metrics satisfying a first threshold criterion, processing units can change a visual property of at least one of the first visual elements, the second visual elements, or the third visual element from a first value to a second value. The modified visual element can correspond to the changed visual property. For example, the first metric of the one or more metrics may correspond to a congestion of a connection between a GPU and a switch. If the congestion satisfies a threshold criterion (e.g., exceeds a congestion limit), a visual property of the visual element representing the connection can be changed from a first value. For example, the connection may initially be represented by a grey line. If the congestion metric of the connection satisfies the threshold criterion, the connection may then be represented by a red line.

At block 410, processing units can present a second view of the 3D visualization of the datacenter state information including the modified visual element.

In some embodiments, the datacenter state information can represent a first timestamp and a second timestamp. The first view of the 3D visualization can correspond to the first timestamp. For example, the first view may depict the configuration and/or metrics of the datacenter at the first timestamp. A second view of the 3D visualization can correspond to the second timestamp. For example, the second view may depict the configuration and/or metrics of the datacenter at the second timestamp. In some embodiments, processing units can present the first view of the 3D visualization and responsive to receiving a first user interaction, present the second view of the 3D visualization. For example, a user may change the timestamp that is being presented by interacting with a visualization control dialog. In some embodiments, the visualization control dialog may include a slider element that can be moved to select a timestamp for visualization.

### Inference and Training Logic

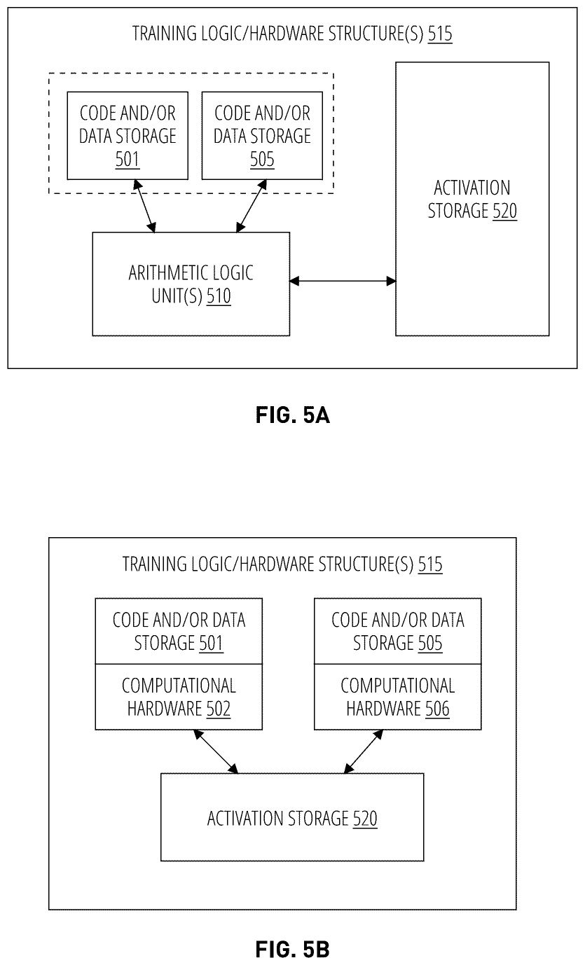

FIG. 5A illustrates inference and/or training logic 515 used to perform inferencing and/or training operations associated with one or more embodiments. For example, inference and/or training logic 515 can be used to perform inferencing and/or train an artificial intelligence (AI) model used to analyze a 3D visualization of a datacenter. For example, an AI model may be configured to interpret visual inputs. The AI model may be able to receive an image (e.g., a 2D representation) of the 3D visualization (e.g., an image of the 3D visualization taken from a first perspective). The image can include representations of visual elements from the 3D visualization. One or more of the visual elements can be displaying metrics associated with the datacenter.

In some embodiments, the AI model may be trained to detect and/or predict one or more metrics of the datacenter based on the image of the 3D visualization. For example, the image may be provided as an input to the AI model. The AI model may generate an output (e.g., a textual output) describing and/or predicting the one or more metrics of the datacenter. As an example, an image depicting a first connection of the datacenter with high congestion may be provided to the AI model as an input. The AI model may generate as an output a prediction describing one or more other connections that may experience congestion in the near future as a result of the first connection being congested.

In some embodiments, the AI model may receive as input an image of the 3D visualization at a first timestamp and may generate as an output an image prediction of how the 3D visualization will appear at a second timestamp in the future. For example, an image depicting a first entity (e.g., a first GPU) of the datacenter with a high temperature at a first timestamp may be provided to the AI model as an input. The first entity may have a red color in the image representing an elevated temperature. Entities surrounding the first entity in the image may have a blue color representing an average temperature (or a cooler temperature relative to the high temperature of the first entity). The AI model may generate as an output an image predicting how the 3D visualization will appear at a second timestamp. For example, the image prediction may depict one or more entities near the first entity with a color indicating a higher temperature at the second timestamp than at the first timestamp.

In some embodiments, the AI model may receive an image of the 3D visualization as an input and may output a textual description of one or more actions that can be performed to remedy any metrics that have exceeded a threshold. For example, the 3D visualization may be configured to only show connections that have a congestion metric that exceeds a predetermined threshold. An image of the 3D visualization may be provided to the AI model as an input. The AI model may generate an output describing one or more actions (e.g., disabling a port on a switch, etc.) that can be taken to reduce congestion on the connections depicted in the image of the 3D visualization.

In some embodiments, the AI model is a convolutional neural network (CNN). In some embodiments, the AI model is a vision language model (VLM). In some embodiments, the AI model has an architecture that allows for image inputs to be converted to textual outputs. In some embodiments, the AI model is trained in a supervised manner. For example, a training set can include pairs of input images and target output predictions (e.g., textual predictions, image predictions, etc.). The AI model can be trained using the training set to more accurately generate the desired output predictions.

In at least one embodiment, inference and/or training logic 515 may include, without limitation, code and/or data storage 501 to store forward and/or output weight and/or input/output data, and/or other parameters to configure neurons or layers of a neural network trained and/or used for inferencing in aspects of one or more embodiments. In at least one embodiment, training logic 515 may include (or be coupled to code and/or data storage 501 that stores) graph code or other software to control timing and/or order, in which weight and/or other parameter information is to be loaded to configure processing units, including logic units, integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 501 may be included with other on-chip or off-chip data storage, including a processor's L1, L2, or L3 cache or system memory.

In at least one embodiment, any portion of code and/or data storage 501 may be internal or external to one or more processors or other hardware logic devices or circuits. In at least one embodiment, code and/or data storage 501 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 501 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a code and/or data storage 505 to store backward and/or output weight and/or input/output data corresponding to neurons or layers of a neural network trained and/or used for inferencing in aspects of one or more embodiments. In at least one embodiment, code and/or data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 515 may include (or be coupled to code and/or data storage 505 that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 505 may be included with other on-chip or off-chip data storage, including a processor's L1, L2, or L3 cache or system memory. In at least one embodiment, any portion of code and/or data storage 505 may be internal or external to one or more processors or other hardware logic devices or circuits. In at least one embodiment, code and/or data storage 505 may be cache memory, DRAM, SRAM, non-volatile memory (e.g., flash memory), or other storage. In at least one embodiment, a choice of whether code and/or data storage 505 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or code and/or data storage 501 and code and/or data storage 505 may be separate storage structures. In at least one embodiment, code and/or data storage 501 and code and/or data storage 505 may be a combined storage structure. In at least one embodiment, code and/or data storage 501 and code and/or data storage 505 may be partially combined and partially separate. In at least one embodiment, any portion of code and/or data storage 501 and code and/or data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 520 that are functions of input/output and/or weight parameter data stored in code and/or data storage 501 and/or code and/or data storage 505. In at least one embodiment, activations stored in activation storage 520 are generated according to linear algebraic and/or matrix-based mathematics performed by ALU(s) 510 in response to performing instructions or other code, wherein weight values stored in code and/or data storage 505 and/or code and/or data storage 501 are used as operands along with other values, such as bias values, gradient information, momentum values, or other parameters or hyperparameters, any or all of which may be stored in code and/or data storage 505 or code and/or code and/or data storage 501 or another storage on or off-chip.

In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALU(s) 510 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or data storage 501, code and/or data storage 505, and activation storage 520 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., flash memory), or other storage. In at least one embodiment, activation storage 520 may be completely or partially within or external to one or more processors or other logical circuits. In at least one embodiment, a choice of whether activation storage 520 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 illustrated in FIG. 5A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, code and/or data storage 501 and code and/or data storage 505, which may be used to store code (e.g., graph code), weight values and/or other information, including bias values, gradient information, momentum values, and/or other parameter or hyperparameter information. In at least one embodiment illustrated in FIG. 5B, each of code and/or data storage 501 and code and/or data storage 505 is associated with a dedicated computational resource, such as computational hardware 502 and computational hardware 506, respectively. In at least one embodiment, each of computational hardware 502 and computational hardware 506 comprises one or more ALUs that perform mathematical functions, such as linear algebraic functions, only on information stored in code and/or data storage 501 and code and/or data storage 505, respectively, the result of which is stored in activation storage 520.

In at least one embodiment, each of code and/or data storage 501 and 505 and corresponding computational hardware 502 and 506, respectively, correspond to different layers of a neural network, such that resulting activation from one storage/computational pair 501/502 of code and/or data storage 501 and computational hardware 502 is provided as an input to a next storage/computational pair 505/506 of code and/or data storage 505 and computational hardware 506, in order to mirror a conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage/computation pairs 501/502 and 505/506 may be included in inference and/or training logic 515.

### Neural Network Training and Deployment

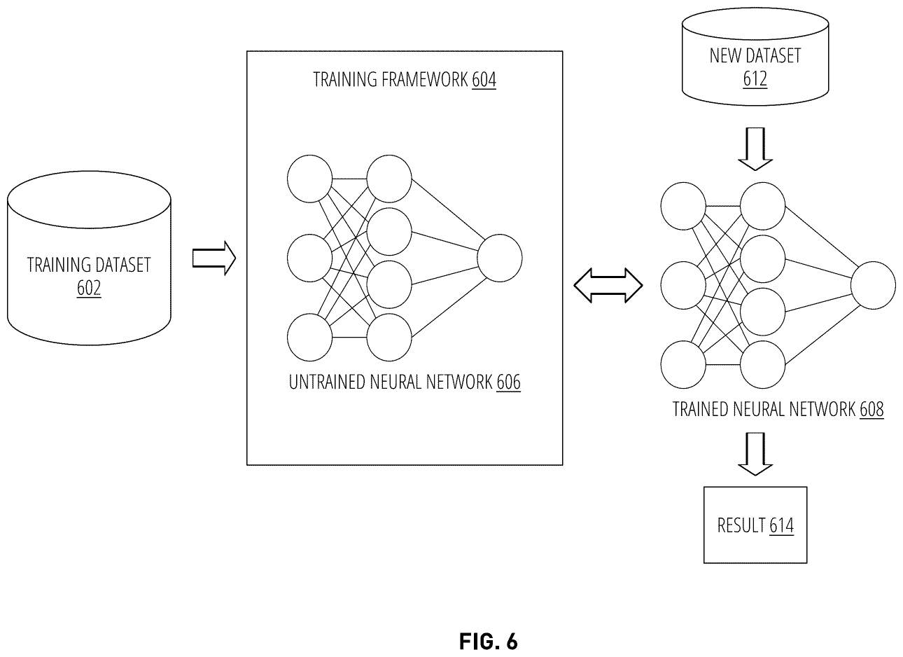

FIG. 6 illustrates training and deployment of a deep neural network, according to at least one embodiment. In at least one embodiment, untrained neural network 606 is trained using a training dataset 602. In at least one embodiment, training framework 604 is a PyTorch framework, whereas in other embodiments, training framework 604 is a TensorFlow, Boost, Caffe, Microsoft Cognitive Toolkit/CNTK, MXNet, Chainer, Keras, Deeplearning4j, or other training framework. In at least one embodiment, training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having a known output and an output of neural network 606 is manually graded. In at least one embodiment, untrained neural network 606 is trained in a supervised manner and processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on input data such as a new dataset 612. In at least one embodiment, training framework 604 trains untrained neural network 606 repeatedly while adjusting weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map in trained neural network 608 capable of performing operations useful in reducing dimensionality of new dataset 612. In at least one embodiment, unsupervised training can also be used to perform anomaly detection, which allows identification of data points in new dataset 612 that deviate from normal patterns of new dataset 612.

In at least one embodiment, semi-supervised learning may be used, which is a technique in which training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new dataset 612 without forgetting knowledge instilled within trained neural network 608 during initial training.

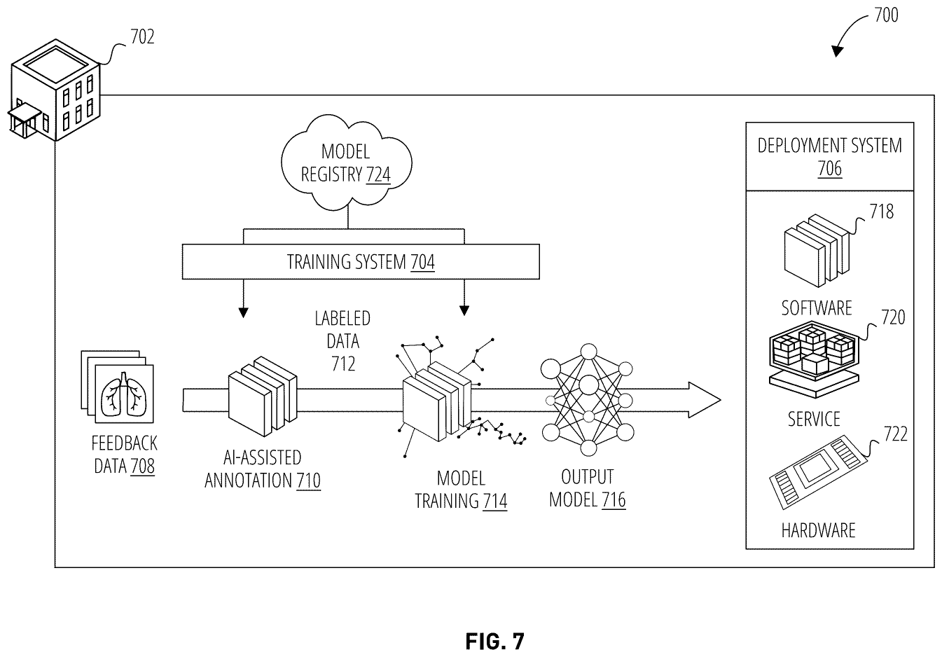

With reference to FIG. 7, FIG. 7 is an example data flow diagram for a process 700 of generating and deploying a processing and inferencing pipeline, according to at least one embodiment. In at least one embodiment, process 700 may be deployed to perform game name recognition analysis and inferencing on user feedback data at one or more facilities 702, such as a data center.

In at least one embodiment, process 700 may be executed within a training system 704 and/or a deployment system 706. In at least one embodiment, training system 704 may be used to perform training, deployment, and embodiment of machine learning models (e.g., neural networks, object detection algorithms, computer vision algorithms, etc.) for use in deployment system 706. In at least one embodiment, deployment system 706 may be configured to offload processing and compute resources among a distributed computing environment to reduce infrastructure requirements at facility 702. In at least one embodiment, deployment system 706 may provide a streamlined platform for selecting, customizing, and implementing virtual instruments for use with computing devices at facility 702. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 706 during execution of applications.

In at least one embodiment, some applications used in advanced processing and inferencing pipelines may use machine learning models or other AI to perform one or more processing steps. In at least one embodiment, machine learning models may be trained at facility 702 using feedback data 708 (such as imaging data) stored at facility 702 or feedback data 708 from another facility or facilities, or a combination thereof. In at least one embodiment, training system 704 may be used to provide applications, services, and/or other resources for generating working, deployable machine learning models for deployment system 706.

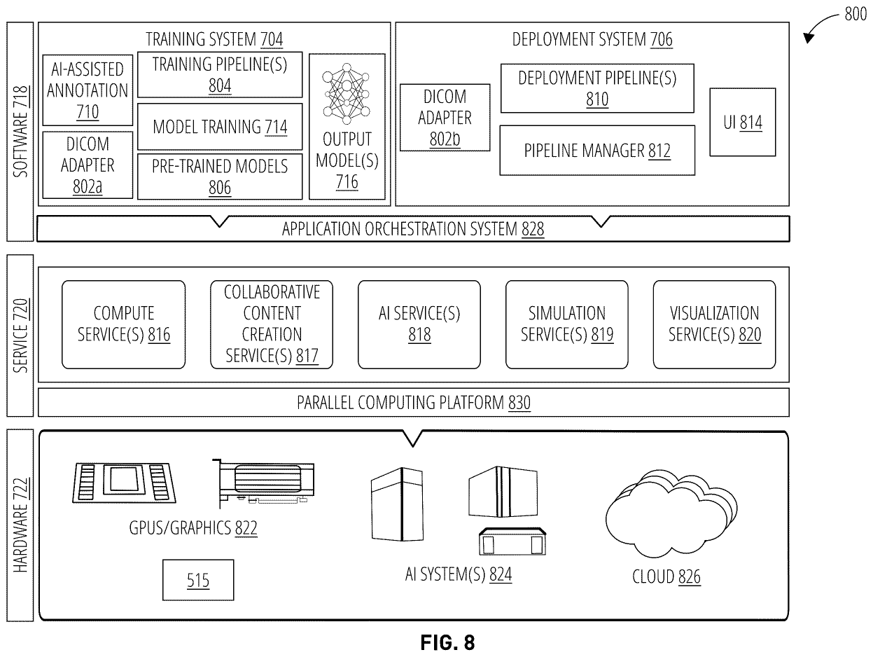

In at least one embodiment, a model registry 724 may be backed by object storage that may support versioning and object metadata. In at least one embodiment, object storage may be accessible through, for example, a cloud storage (e.g., a cloud 826 of FIG. 8) compatible application programming interface (API) from within a cloud platform. In at least one embodiment, machine learning models within model registry 724 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline(s) 804 (FIG. 8) may include a scenario where facility 702 is training their own machine learning model or has an existing machine learning model that needs to be optimized or updated. In at least one embodiment, feedback data 708 may be received from various channels, such as forums, web forms, or the like. In at least one embodiment, once feedback data 708 is received, AI-assisted annotation 710 may be used to aid in generating annotations corresponding to feedback data 708 to be used as ground truth data for a machine learning model. In at least one embodiment, AI-assisted annotation 710 may include one or more machine learning models (e.g., convolutional neural networks (CNNs)) that may be trained to generate annotations corresponding to certain types of feedback data 708 (e.g., from certain devices) and/or certain types of anomalies in feedback data 708. In at least one embodiment, AI-assisted annotations 710 may then be used directly, or may be adjusted or fine-tuned using an annotation tool, to generate ground truth data. In at least one embodiment, in some examples, labeled data 712 may be used as ground truth data for training a machine learning model. In at least one embodiment, AI-assisted annotations 710, labeled data 712, or a combination thereof may be used as ground truth data for training a machine learning model, e.g., via model training 714 in FIG. 7 and/or FIG. 8. In at least one embodiment, a trained machine learning model may be referred to as an output model 716, and may be used by deployment system 706, as described herein.

In at least one embodiment, training pipeline(s) 804 (FIG. 8) may include a scenario where facility 702 needs a machine learning model for use in performing one or more processing tasks for one or more applications in deployment system 706, but facility 702 may not currently have such a machine learning model (or may not have a model that is optimized, efficient, or effective for such purposes). In at least one embodiment, an existing machine learning model may be selected from model registry 724. In at least one embodiment, model registry 724 may include machine learning models trained to perform a variety of different inference tasks on imaging data. In at least one embodiment, machine learning models in model registry 724 may have been trained on imaging data from different facilities than facility 702 (e.g., facilities that are remotely located). In at least one embodiment, machine learning models may have been trained on imaging data from one location, two locations, or any number of locations. In at least one embodiment, when being trained on imaging data, which may be a form of feedback data 708, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained - or partially trained - at one location, a machine learning model may be added to model registry 724. In at least one embodiment, a machine learning model may then be retrained, or updated, at any number of other facilities, and a retrained or updated model may be made available in model registry 724. In at least one embodiment, a machine learning model may then be selected from model registry 724—and referred to as output model(s) 716—and may be used in deployment system 706 to perform one or more processing tasks for one or more applications of a deployment system.

In at least one embodiment, training pipeline(s) 804 (FIG. 8) may be used in a scenario that includes facility 702 requiring a machine learning model for use in performing one or more processing tasks for one or more applications in deployment system 706, but facility 702 may not currently have such a machine learning model (or may not have a model that is optimized, efficient, or effective for such purposes). In at least one embodiment, a machine learning model selected from model registry 724 might not be fine-tuned or optimized for feedback data 708 generated at facility 702 because of differences in populations, genetic variations, robustness of training data used to train a machine learning model, diversity in anomalies of training data, and/or other issues with training data. In at least one embodiment, AI-assisted annotation 710 may be used to aid in generating annotations corresponding to feedback data 708 to be used as ground truth data for retraining or updating a machine learning model. In at least one embodiment, labeled data 712 may be used as ground truth data for training a machine learning model. In at least one embodiment, retraining or updating a machine learning model may be referred to as model training 714. In at least one embodiment, model training 714 may include data—e.g., AI-assisted annotations 710, labeled data 712, or a combination thereof—that may be used as ground truth data for retraining or updating a machine learning model.

In at least one embodiment, deployment system 706 may include software 718, service 720, hardware 722, and/or other components, features, and functionality. In at least one embodiment, deployment system 706 may include a software “stack,” such that software 718 may be built on top of service 720 and may use service 720 to perform some or all of processing tasks, and service 720 and software 718 may be built on top of hardware 722 and use hardware 722 to execute processing, storage, and/or other compute tasks of deployment system 706.

In at least one embodiment, software 718 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 708 (or other data types, such as those described herein). In at least one embodiment, an advanced processing and inferencing pipeline may be defined based on selections of different containers that are desired or required for processing feedback data 708, in addition to containers that receive and configure imaging data for use by each container and/or for use by facility 702 after processing through a pipeline (e.g., to convert outputs back to a usable data type for storage and display at facility 702). In at least one embodiment, a combination of containers within software 718 (e.g., that make up a pipeline) may be referred to as a virtual instrument (as described in more detail herein), and a virtual instrument may leverage service 720 and hardware 722 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 716 of training system 704.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 724 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 720 as a system (e.g., system 800 of FIG. 8). In at least one embodiment, once validated by system 800 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 800 of FIG. 8). In at least one embodiment, completed and validated applications or containers may be stored in a container registry and associated machine learning models may be stored in model registry 724. In at least one embodiment, a requesting entity that provides an inference or image processing request may browse a container registry and/or model registry 724 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 706 (e.g., a cloud) to perform processing of a data processing pipeline. In at least one embodiment, processing by deployment system 706 may include referencing selected elements (e.g., applications, containers, models, etc.) from a container registry and/or model registry 724. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, service 720 may be leveraged. In at least one embodiment, service 720 may include compute services, collaborative content creation services, simulation services, artificial intelligence (AI) services, visualization services, and/or other service types. In at least one embodiment, service 720 may provide functionality that is common to one or more applications in software 718, so functionality may be abstracted to a service that may be called upon or leveraged by applications. In at least one embodiment, functionality provided by service 720 may run dynamically and more efficiently, while also scaling well by allowing applications to process data in parallel, e.g., using a parallel computing platform 830 (FIG. 8). In at least one embodiment, rather than each application that shares a same functionality offered by a service 720 being required to have a respective instance of service 720, service 720 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 720 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software 718 implementing advanced processing and inferencing pipeline may be streamlined because each application may call upon the same inference service to perform one or more inferencing tasks.

In at least one embodiment, hardware 722 may include GPUs, CPUs, data processing units (DPUs), an AI/deep learning system (e.g., an AI supercomputer, such as NVIDIA's DGX™ supercomputer system), a cloud platform, or a combination thereof. In at least one embodiment, different types of hardware 722 may be used to provide efficient, purpose-built support for software 718 and service 720 in deployment system 706. In at least one embodiment, use of GPU processing may be implemented for processing locally (e.g., at facility 702), within an AI/deep learning system, in a cloud system, and/or in other processing components of deployment system 706 to improve efficiency, accuracy, and efficacy of game name recognition.

In at least one embodiment, software 718 and/or service 720 may be optimized for GPU processing with respect to deep learning, machine learning, and/or high-performance computing, simulation, and visual computing, as non-limiting examples. In at least one embodiment, at least some of the computing environment of deployment system 706 and/or training system 704 may be executed in a datacenter or one or more supercomputers or high performance computing systems, with GPU-optimized software (e.g., hardware and software combination of NVIDIA's DGX™ system). In at least one embodiment, hardware 722 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 8 is a system diagram for an example system 800 for generating and deploying a deployment pipeline, according to at least one embodiment. In at least one embodiment, system 800 may be used to implement process 700 of FIG. 7 and/or other processes including advanced processing and inferencing pipelines. In at least one embodiment, system 800 may include training system 704 and deployment system 706. In at least one embodiment, training system 704 and deployment system 706 may be implemented using software 718, services 720, and/or hardware 722, as described herein.

In at least one embodiment, system 800 (e.g., training system 704 and/or deployment system 706) may implemented in a cloud computing environment (e.g., using cloud 826). In at least one embodiment, system 800 may be implemented locally with respect to a facility, or as a combination of both cloud and local computing resources. In at least one embodiment, access to APIs in cloud 826 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 800, may be restricted to a set of public internet service providers (ISPs) that have been vetted or authorized for interaction.

In at least one embodiment, various components of system 800 may communicate between and among one another using any of a variety of different network types, including but not limited to local area networks (LANs) and/or wide area networks (WANs) via wired and/or wireless communication protocols. In at least one embodiment, communication between facilities and components of system 800 (e.g., for transmitting inference requests, for receiving results of inference requests, etc.) may be communicated over a data bus or data busses, wireless data protocols (e.g., Wi-Fi), wired data protocols (e.g., Ethernet), etc.

In at least one embodiment, training system 704 may execute training pipelines 804, similar to those described herein with respect to FIG. 7. In at least one embodiment, where one or more machine learning models are to be used in deployment pipeline(s) 810 by deployment system 706, training pipeline(s) 804 may be used to train or retrain one or more (e.g., pre-trained) models, and/or implement one or more of pre-trained models 806 (e.g., without a need for retraining or updating). In at least one embodiment, as a result of training pipeline(s) 804, output model(s) 716 may be generated. In at least one embodiment, training pipeline(s) 804 may include any number of processing steps, AI-assisted annotation 710, labeling or annotating of feedback data 708 to generate labeled data 712, model selection from a model registry, model training 714, training, retraining, or updating models, and/or other processing steps. In at least one embodiment, DICOM adapter 802a can be used to access DICOM data. In at least one embodiment, for different machine learning models used by deployment system 706, different training pipeline(s) 804 may be used. In at least one embodiment, training pipeline(s) 804, similar to a first example described with respect to FIG. 7, may be used for a first machine learning model, training pipeline(s) 804, similar to a second example described with respect to FIG. 7, may be used for a second machine learning model, and training pipeline(s) 804, similar to a third example described with respect to FIG. 7, may be used for a third machine learning model. In at least one embodiment, any combination of tasks within training system 704 may be used depending on what is required for each respective machine learning model. In at least one embodiment, one or more of machine learning models may already be trained and ready for deployment so machine learning models may not undergo any processing by training system 704 and may be implemented by deployment system 706.

In at least one embodiment, output model(s) 716 and/or pre-trained models 806 may include any types of machine learning models depending on embodiment. In at least one embodiment, and without limitation, machine learning models used by system 800 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipeline(s) 804 may include AI-assisted annotation. In at least one embodiment, labeled data 712 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 708 (or other data type used by machine learning models), there may be corresponding ground truth data generated by training system 704. In at least one embodiment, AI-assisted annotation may be performed as part of deployment pipeline(s) 810; either in addition to, or in lieu of, AI-assisted annotation included in training pipeline(s) 804. In at least one embodiment, system 800 may include a multi-layer platform that may include a software layer (e.g., software 718) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 702. In at least one embodiment, applications may then call or execute one or more services 720 for performing compute, AI, or visualization tasks associated with respective applications, and software 718 and/or services 720 may leverage hardware 722 to perform processing tasks in an effective and efficient manner.

In at least one embodiment, deployment system 706 may execute deployment pipelines 810. In at least one embodiment, deployment pipeline(s) 810 may include any number of applications that may be sequentially, non-sequentially, or otherwise applied to feedback data (and/or other data types), including AI-assisted annotation, as described above. In at least one embodiment, as described herein, a deployment pipeline(s) 810 for an individual device may be referred to as a virtual instrument for a device. In at least one embodiment, for a single device, there may be more than one deployment pipeline(s) 810 depending on information desired from data generated by a device.

In at least one embodiment, applications available for deployment pipeline(s) 810 may include any application that may be used for performing processing tasks on feedback data or other data from devices. In at least one embodiment, because various applications may share common image operations, in some embodiments, a data augmentation library (e.g., as one of services 720) may be used to accelerate these operations. In at least one embodiment, to avoid bottlenecks of conventional processing approaches that rely on CPU processing, parallel computing platform 830 may be used for GPU acceleration of these processing tasks.

In at least one embodiment, deployment system 706 may include a user interface (UI) 814 (e.g., a graphical user interface, a web interface, etc.) that may be used to select applications for inclusion in deployment pipeline(s) 810, arrange applications, modify or change applications or parameters or constructs thereof, use and interact with deployment pipeline(s) 810 during set-up and/or deployment, and/or to otherwise interact with deployment system 706. In at least one embodiment, although not illustrated with respect to training system 704, UI 814 (or a different user interface) may be used for selecting models for use in deployment system 706, for selecting models for training, or retraining, in training system 704, and/or for otherwise interacting with training system 704.

In at least one embodiment, pipeline manager 812 may be used, in addition to an application orchestration system 828, to manage interaction between applications or containers of deployment pipeline(s) 810 and services 720 and/or hardware 722. In at least one embodiment, pipeline manager 812 may be configured to facilitate interactions from application to application, from application to service 720, and/or from application or service to hardware 722. In at least one embodiment, although illustrated as included in software 718, this is not intended to be limiting, and in some examples pipeline manager 812 may be included in services 720. In at least one embodiment, application orchestration system 828 (e.g., Kubernetes, DOCKER, etc.) may include a container orchestration system that may group applications into containers as logical units for coordination, management, scaling, and deployment. In at least one embodiment, by associating applications from deployment pipeline(s) 810 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 812 and application orchestration system 828. In at least one embodiment, so long as an expected input and/or output of each container or application is known by a system (e.g., based on constructs of applications or containers), application orchestration system 828 and/or pipeline manager 812 may facilitate communication among and between, and sharing of resources among and between, each of the applications or containers. In at least one embodiment, because one or more of applications or containers in deployment pipeline(s) 810 may share the same services and resources, application orchestration system 828 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 828) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 720 leveraged and shared by applications or containers in deployment system 706 may include compute service(s) 816, collaborative content creation service(s) 817, AI service(s) 818, simulation service(s) 819, visualization service(s) 820, and/or other service types. In at least one embodiment, applications may call (e.g., execute) one or more of services 720 to perform processing operations for an application. In at least one embodiment, compute service(s) 816 may be leveraged by applications to perform super-computing or other high-performance computing (HPC) tasks. In at least one embodiment, compute service(s) 816 may be leveraged to perform parallel processing (e.g., using a parallel computing platform 830) for processing data through one or more of applications and/or one or more tasks of a single application, substantially simultaneously. In at least one embodiment, parallel computing platform 830 (e.g., NVIDIA's CUDA®) may enable general purpose computing on GPUs (GPGPU) (e.g., GPUs/graphics 822). In at least one embodiment, a software layer of parallel computing platform 830 may provide access to virtual instruction sets and parallel computational elements of GPUs, for execution of compute kernels. In at least one embodiment, parallel computing platform 830 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 830 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 818 may be leveraged to perform inferencing services for executing machine learning model(s) associated with applications (e.g., tasked with performing one or more processing tasks of an application). In at least one embodiment, AI service(s) 818 may leverage AI system(s) 824 to execute machine learning model(s) (e.g., neural networks, such as CNNs) for segmentation, reconstruction, object detection, feature detection, classification, and/or other inferencing tasks. In at least one embodiment, applications of deployment pipeline(s) 810 may use one or more of output model(s) 716 from training system 704 and/or other models of applications to perform inference on imaging data (e.g., DICOM data, RIS data, CIS data, REST compliant data, RPC data, raw data, etc.). For example, DICOM adapter 802b may be used to access DICOM data. In at least one embodiment, two or more examples of inferencing using application orchestration system 828 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 828 may distribute resources (e.g., services 720 and/or hardware 722) based on priority paths for different inferencing tasks of AI service(s) 818.

In at least one embodiment, shared storage may be mounted to AI service(s) 818 within system 800. In at least one embodiment, shared storage may operate as a cache (or other storage device type) and may be used to process inference requests from applications. In at least one embodiment, when an inference request is submitted, a request may be received by a set of API instances of deployment system 706, and one or more instances may be selected (e.g., for best fit, for load balancing, etc.) to process a request. In at least one embodiment, to process a request, a request may be entered into a database, a machine learning model may be located from model registry 724 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 812) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 720 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 826, and an inference service may perform inferencing on a GPU.

In at least one embodiment, visualization service(s) 820 may be leveraged to generate visualizations for viewing outputs of applications and/or deployment pipeline(s) 810. In at least one embodiment, GPUs/graphics 822 may be leveraged by visualization service(s) 820 to generate visualizations. In at least one embodiment, rendering effects, such as ray-tracing or other light transport simulation techniques, may be implemented by visualization service(s) 820 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 820 may include an internal visualizer, cinematics, and/or other rendering or image processing capabilities or functionality (e.g., ray tracing, rasterization, internal optics, etc.).

In at least one embodiment, hardware 722 may include GPUs/graphics 822, AI system(s) 824, cloud 826, and/or any other hardware used for executing training system 704 and/or deployment system 706. In at least one embodiment, GPUs/graphics 822 (e.g., NVIDIA's TESLA® and/or QUADRO® GPUs) may include any number of GPUs that may be used for executing processing tasks of compute service(s) 816, collaborative content creation service(s) 817, AI service(s) 818, simulation service(s) 819, visualization service(s) 820, other services, and/or any of features or functionality of software 718. For example, with respect to AI service(s) 818, GPUs/graphics 822 may be used to perform pre-processing on imaging data (or other data types used by machine learning models), post-processing on outputs of machine learning models, and/or to perform inferencing (e.g., to execute machine learning models). In at least one embodiment, cloud 826, AI system(s) 824, and/or other components of system 800 may use GPUs/graphics 822. In at least one embodiment, cloud 826 may include a GPU-optimized platform for deep learning tasks. In at least one embodiment, AI system(s) 824 may use GPUs, and cloud 826—or at least a portion tasked with deep learning or inferencing—may be executed using one or more AI system(s)s 824. As such, although hardware 722 is illustrated as discrete components, this is not intended to be limiting, and any components of hardware 722 may be combined with, or leveraged by, any other components of hardware 722.

In at least one embodiment, AI system(s) 824 may include a purpose-built computing system (e.g., a super-computer or an HPC) configured for inferencing, deep learning, machine learning, and/or other artificial intelligence tasks. In at least one embodiment, AI system(s) 824 (e.g., NVIDIA's DGX™) may include GPU-optimized software (e.g., a software stack) that may be executed using a plurality of GPUs/graphics 822, in addition to CPUs, RAM, storage, and/or other components, features, or functionality. In at least one embodiment, one or more AI system(s)s 824 may be implemented in cloud 826 (e.g., in a data center) for performing some or all of AI-based processing tasks of system 800.

In at least one embodiment, cloud 826 may include a GPU-accelerated infrastructure (e.g., NVIDIA's NGC™) that may provide a GPU-optimized platform for executing processing tasks of system 800. In at least one embodiment, cloud 826 may include an AI system(s) 824 for performing one or more of AI-based tasks of system 800 (e.g., as a hardware abstraction and scaling platform). In at least one embodiment, cloud 826 may integrate with application orchestration system 828 leveraging multiple GPUs to enable seamless scaling and load balancing between and among applications and services 720. In at least one embodiment, cloud 826 may be tasked with executing at least some of services 720 of system 800, including compute service(s) 816, AI service(s) 818, and/or visualization service(s) 820, as described herein. In at least one embodiment, cloud 826 may perform small and large batch inference (e.g., executing NVIDIA's TensorRT™), provide an accelerated parallel computing platform 830 (e.g., NVIDIA's CUDA®), execute application orchestration system 828 (e.g., KUBERNETES), provide a graphics rendering API and platform (e.g., for ray-tracing, 2D graphics, 3D graphics, and/or other rendering techniques to produce higher quality cinematics), and/or may provide other functionality for system 800. In at least one embodiment, parallel computing platform 830 may include an API.

In at least one embodiment, in an effort to preserve patient confidentiality (e.g., where patient data or records are to be used off-premises), cloud 826 may include a registry, such as a deep learning container registry. In at least one embodiment, a registry may store containers for instantiations of applications that may perform pre-processing, post-processing, or other processing tasks on patient data. In at least one embodiment, cloud 826 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Processing Device Architecture

FIG. 9 is a block diagram illustrating an exemplary computer system 900, which may be a system with interconnected devices and components, a system-on-a-chip (SOC) or some combination thereof formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment, computer system 900 may be a multiprocessor system. In at least one embodiment, processor 902 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs.

In at least one embodiment, processor 902 may include, without limitation, a Level 2 (“L2”) internal cache memory (“cache”) 904. The L2 cache can serve as a secondary, larger, and somewhat slower cache compared to the L1 cache that is still faster than accessing the main memory (e.g., via the memory controller hub 916). Thus, the L2 cache can enhance performance by reducing the time the processor spends accessing the main memory. In at least one embodiment, processor 902 may have a single internal L2 cache or multiple levels of internal cache. In embodiments where the processor 902 is a multi-core processor, the L2 cache can be shared among multiple cores of processor 902, providing a larger, intermediate level of cache memory for more than one processing core. In at least one embodiment, L2 cache memory may reside external to processor 902.

In at least one embodiment, processor 902 may include, without limitation, a Level 3 (“L3”) internal cache memory (“cache”) 904. The L3 cache can serve as a tertiary, larger, and slower cache compared to both the L1 and L2 caches. The L3 cache can enhance performance by reducing the time the processor spends accessing the main memory. The L3 cache can be shared among multiple cores of processor 902, providing a larger pool of fast-access memory for data for the processor cores. In at least one embodiment, processor 902 may have a single internal L3 cache or multiple levels of internal cache. In at least one embodiment, L3 cache memory may reside external to processor 902. Other embodiments may also include any combination of internal or external L1, L2, and/or L3 caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 932, which may include in some embodiments, a data processing unit. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 915 are used to perform inferencing and/or training operations associated with one or more embodiments. The inference and/or training logic 915 may include same or similar features of training logic/hardware structure(s) 515. Details training logic/hardware structure(s) 515 are provided in conjunction with FIG. 5A and/or FIG. 5B. In at least one embodiment, inference and/or training logic 915 may be used in system FIG. 9 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

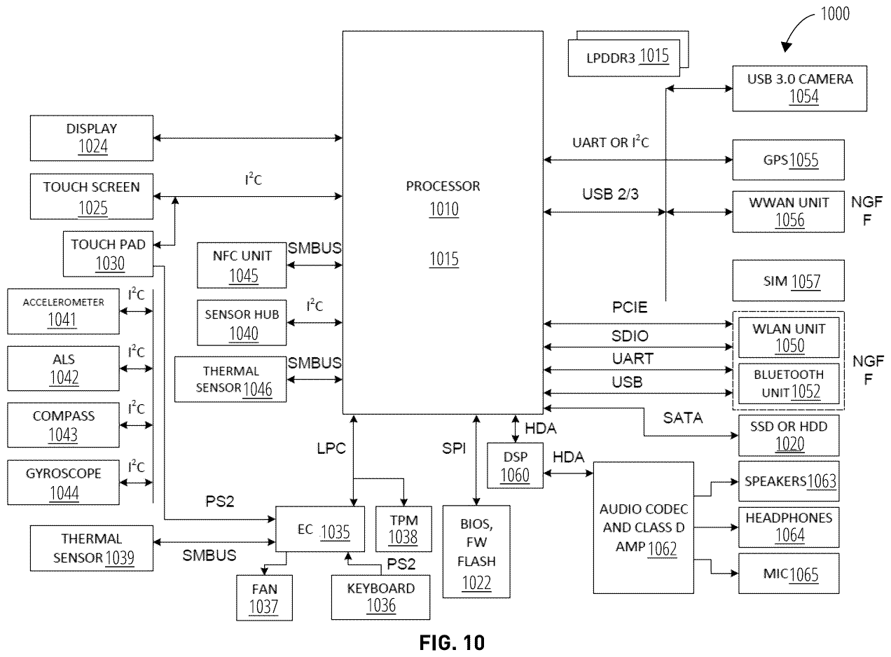

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, an edge device, an IoT device, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a I2C bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speaker 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic/hardware structures 515 are used to perform inferencing and/or training operations associated with one or more embodiments. Details regarding training logic/hardware structure(s) 515 are provided in conjunction with FIG. 5A and/or FIG. 5B. In at least one embodiment, inference and/or training logic structures 515 may be used in system FIG. 10 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

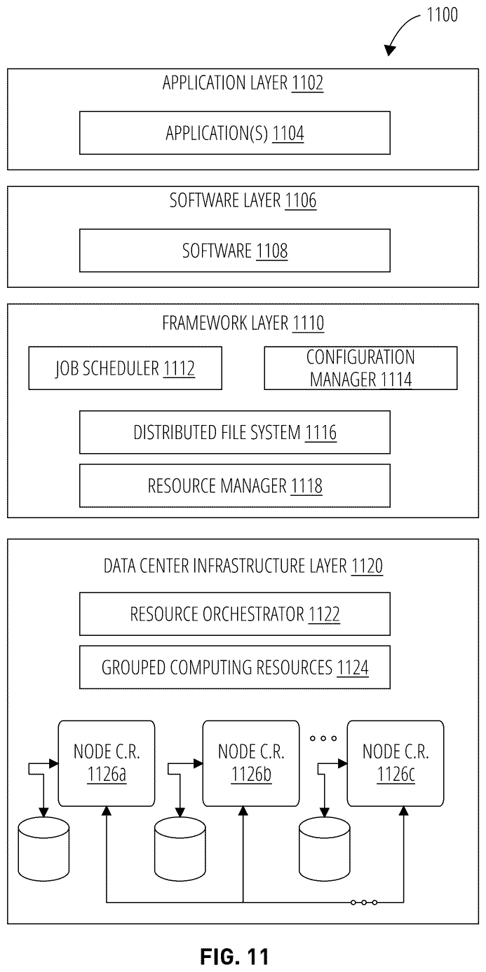

FIG. 11 illustrates an exemplary data center 1100, according to at least one embodiment. In at least one embodiment, data center 1100 includes, without limitation, a data center infrastructure layer 1120, a framework layer 1110, a software layer 1106 and an application layer 1102.

In at least one embodiment, as shown in FIG. 11, data center infrastructure layer 1120 may include a resource orchestrator 1122, grouped computing resources 1124, and node computing resources (“node C.R. s”) 1126a-1126c, where “c” represents any whole, positive integer. In at least one embodiment, node C.R.s 1126a-1126c may include, but are not limited to, any number of central processing units (“CPUs”) or other processors (including accelerators, field programmable gate arrays (“FPGAs”), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1126a-1126c may be a server having one or more of above-mentioned computing resources.

In at least one embodiment, grouped computing resources 1124 may include separate groupings of node C.R.s housed within one or more racks (not shown), or many racks housed in data centers at various geographical locations (also not shown). Separate groupings of node C.R.s within grouped computing resources 1124 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1122 may configure or otherwise control one or more node C.R.s 1126a-1126c and/or grouped computing resources 1124. In at least one embodiment, resource orchestrator 1122 may include a software design infrastructure (“SDI”) management entity for data center 1100. In at least one embodiment, resource orchestrator 1122 may include hardware, software or some combination thereof.

In at least one embodiment, as shown in FIG. 11, framework layer 1110 includes, without limitation, a job scheduler 1112, a configuration manager 1114, a resource manager 1118, and a distributed file system 1116. In at least one embodiment, framework layer 1110 may include a framework to support software 1108 of software layer 1106 and/or one or more application(s) 1104 of application layer 1102. In at least one embodiment, software 1108 or application(s) 1104 may respectively include web-based service software or applications, such as those provided by Amazon Web Services, Google Cloud and Microsoft Azure. In at least one embodiment, framework layer 1110 may be, but is not limited to, a type of free and open-source software web application framework such as Apache Spark™ (hereinafter “Spark”) that may utilize distributed file system 1116 for large-scale data processing (e.g., “big data”). In at least one embodiment, job scheduler 1112 may include a Spark driver to facilitate scheduling of workloads supported by various layers of data center 1100. In at least one embodiment, configuration manager 1114 may be capable of configuring different layers such as software layer 1106 and framework layer 1110, including Spark and distributed file system 1116 for supporting large-scale data processing. In at least one embodiment, resource manager 1118 may be capable of managing clustered or grouped computing resources mapped to or allocated for support of distributed file system 1116 and job scheduler 1112. In at least one embodiment, clustered or grouped computing resources may include grouped computing resources 1124 at data center infrastructure layer 1120. In at least one embodiment, resource manager 1118 may coordinate with resource orchestrator 1122 to manage these mapped or allocated computing resources.

In at least one embodiment, software 1108 included in software layer 1106 may include software used by at least portions of node C.R.s 1126a-1126c, grouped computing resources 1124, and/or distributed file system 1116 of framework layer 1110. One or more types of software may include, but are not limited to, Internet web page search software, e-mail virus scan software, database software, and streaming video content software.

In at least one embodiment, application(s) 1104 included in application layer 1102 may include one or more types of applications used by at least portions of node C.R.s 1126a-1126c, grouped computing resources 1124, and/or distributed file system 1116 of framework layer 1110. In at least one or more types of applications may include, without limitation, CUDA applications, 5G network applications, artificial intelligence application, data center applications, and/or variations thereof.

In at least one embodiment, any of configuration manager 1114, resource manager 1118, and resource orchestrator 1122 may implement any number and type of self-modifying actions based on any amount and type of data acquired in any technically feasible fashion. In at least one embodiment, self-modifying actions may relieve a data center operator of data center 1100 from making possibly bad configuration decisions and possibly avoiding underutilized and/or poor performing portions of a data center.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising
receiving datacenter state information representing a plurality of entities, one or more connections between the plurality of entities, and one or more entity properties for at least a first entity of the plurality of entities; and
generating a first view of a three-dimensional (3D) visualization of the datacenter state information, wherein the 3D visualization of the datacenter state information comprises at least:
first visual elements representing a first subset of the plurality of entities;
second visual elements representing a second subset of the plurality of entities; and
a third visual element representing a first connection of the one or more connections, wherein a spatial position of at least a first visual element of the first visual elements is determined based on the one or more entity properties.

2. The method of claim 1, wherein:
the first visual elements have a first visual property comprising at least one of a shape, a color, or a size;
the second visual elements have a second visual property comprising at least one of a shape, a color, or a size; and
the first visual property is different than the second visual property.

3. The method of claim 1, wherein a first visual elements subset of the first visual elements is positioned spatially within the 3D visualization based on a first entity property of each entity represented by the first visual elements subset.

4. The method of claim 1, wherein a first visual elements subset of the first visual elements is positioned spatially within the 3D visualization based on a combination of a first entity property and a second entity property of each entity represented by the first visual elements subset.

5. The method of claim 1, wherein:
a particular visual element of the first visual elements represents at least a second entity and a third entity of the plurality of entities; and
the second entity and the third entity of the plurality of entities have a common entity property value.

6. The method of claim 1, further comprising, responsive to receiving a first user interaction, presenting a second view of the 3D visualization of the datacenter state information, wherein the second view of the 3D visualization of the datacenter state information has a different perspective than the first view of the 3D visualization of the datacenter state information.

7. The method of claim 1, wherein the datacenter state information further represents one or more metrics of a datacenter corresponding to the datacenter state information; and wherein the method further comprises:
generating a modified visual element by modifying at least one of the first visual elements, the second visual elements, or the third visual element based on the one or more metrics of the datacenter; and
presenting a second view of the 3D visualization of the datacenter state information comprising the modified visual element.

8. The method of claim 7, wherein generating a modified visual element by modifying at least one of the first visual elements, the second visual elements, or the third visual element based on the one or more metrics of the datacenter comprises:
responsive to a first metric of the one or more metrics satisfying a first threshold criterion, changing a visual property of at least one of the first visual elements, the second visual elements, or the third visual element from a first value to a second value, wherein the modified visual element corresponds to the changed visual property.

9. The method of claim 1, wherein the third visual element representing the first connection of the one or more connections has an associated third visual property; and wherein the third visual property depicts a direction associated with the first connection.

10. The method of claim 1, wherein the datacenter state information further represents a first timestamp and a second timestamp, wherein the first view of the 3D visualization of the datacenter state information corresponds to the first timestamp; and wherein the method further comprises, responsive to receiving a first user interaction, presenting a second view of the 3D visualization of the datacenter state information corresponding to the second timestamp.

11. A system comprising:
a memory; and
one or more processors, coupled to the memory, to:
receive datacenter state information representing a plurality of entities, one or more connections between the plurality of entities, and one or more entity properties for at least a first entity of the plurality of entities; and
generate a first view of a three-dimensional (3D) visualization of the datacenter state information, wherein the 3D visualization of the datacenter state information comprises at least:
first visual elements representing a first subset of the plurality of entities;
second visual elements representing a second subset of the plurality of entities; and
a third visual element representing a first connection of the one or more connections, wherein a spatial position of at least a first visual element of the first visual elements is determined based on the one or more entity properties.

12. The system of claim 11, wherein:
the first visual elements have a first visual property comprising at least one of a shape, a color, or a size;
the second visual elements have a second visual property comprising at least one of a shape, a color, or a size; and
the first visual property is different than the second visual property.

13. The system of claim 11, wherein a first visual elements subset of the first visual elements is positioned spatially within the 3D visualization based on a first entity property of each entity represented by the first visual elements subset.

14. The system of claim 11, wherein a first visual elements subset of the first visual elements is positioned spatially within the 3D visualization based on a combination of a first entity property and a second entity property of each entity represented by the first visual elements subset.

15. The system of claim 11, wherein:
a particular visual element of the first visual elements represents at least a second entity and a third entity of the plurality of entities; and
the second entity and the third entity of the plurality of entities have a common entity property value.

16. The system of claim 11, wherein the one or more processors are further to, responsive to receiving a first user interaction, present a second view of the 3D visualization of the datacenter state information, wherein the second view of the 3D visualization of the datacenter state information has a different perspective than the first view of the 3D visualization of the datacenter state information.

17. The system of claim 11, wherein the datacenter state information further represents one or more metrics of a datacenter corresponding to the datacenter state information; and wherein the one or more processors are further to:
generate a modified visual element by modifying at least one of the first visual elements, the second visual elements, or the third visual element based on the one or more metrics of the datacenter; and
present a second view of the 3D visualization of the datacenter state information comprising the modified visual element.

18. The system of claim 17, wherein to generate a modified visual element by modifying at least one of the first visual elements, the second visual elements, or the third visual element based on the one or more metrics of the datacenter, the one or more processors are to:
responsive to a first metric of the one or more metrics satisfying a first threshold criterion, change a visual property of at least one of the first visual elements, the second visual elements, or the third visual element from a first value to a second value, wherein the modified visual element corresponds to the changed visual property.

19. The system of claim 11, wherein the third visual element representing the first connection of the one or more connections has an associated third visual property; and wherein the third visual property depicts a direction associated with the first connection.

20. One or more processors comprising processing circuitry to perform operations comprising:
receiving datacenter state information representing a plurality of entities, one or more connections between the plurality of entities, and one or more entity properties for at least a first entity of the plurality of entities; and
generating a first view of a three-dimensional (3D) visualization of the datacenter state information, wherein the 3D visualization of the datacenter state information comprises at least:
first visual elements representing a first subset of the plurality of entities;
second visual elements representing a second subset of the plurality of entities; and
a third visual element representing a first connection of the one or more connections, wherein a spatial position of at least a first visual element of the first visual elements is determined based on the one or more entity properties.
